(19) United States
(12) Patent Application Publication
(10) Pub. No.: US 2026/0030667 A1
(43) Pub. Date: Jan. 29, 2026

(54) Enrichment and Reconciliation of Financial Transaction Data

(71) Applicant: Statement Technologies LTD, Tel Aviv (IL)

(72) Inventors: Idan VLODINGER, New York, NY (US); Shahar LAHAV, Tel Aviv (IL)

(21) Appl. No.: 18/780,810

(22) Filed: Jul. 23, 2024

(51) Int. Cl. G06Q 40/02

(52) U.S. Cl. CPC G06Q 40/02

(57) ABSTRACT

A system configured to provide data pertaining to a record, comprising a processing circuitry, the processing circuitry configured to perform the following method: obtain, from at least one first source, a first record indicative of an actual financial transaction, paid via the first source; perform enrichment on the first record, thereby determining at least one of: a counterparty associated with the first record; and a financial classification category associated with the first record, wherein the performing of the enrichment utilizes at least one machine learning model trained to identify correspondence, of first records indicative of actual financial transactions associated with a business entity, to second data, wherein the second data are obtained from at least one second source, distinct from the at least one first source; derive an enriched first record, based on the enrichment; and provide the enriched first record.

### TECHNICAL FIELD

The presently disclosed subject matter relates to the field of enrichment of data records.

### BACKGROUND

Systems exist, supporting business entities such as corporations, which receive records of e.g. bank transactions from a bank at which the entity has an account.

Acknowledgement of the above references herein is not to be inferred as meaning that these are in any way relevant to the patentability of the presently disclosed subject matter.

### GENERAL DESCRIPTION

The following are example embodiments of the presently disclosed subject matter.

According to a first aspect of the presently disclosed subject matter there is presented a computerized method providing data pertaining to a record, the method performed by a processing circuitry of a system, the computerized method comprising:
a. obtaining, from at least one first source, a first record indicative of an actual financial transaction, paid via the first source;
b. performing enrichment on the first record, thereby determining at least one of: a counterparty associated with the first record; and a financial classification category associated with the first record,
where the performing of the enrichment utilizes at least one machine learning model trained to identify correspondence, of first records indicative of actual financial transactions associated with a business entity, to second data,
where the second data are obtained from at least one second source, distinct from the at least one first source;
c. deriving an enriched first record, based on the enrichment; and
d. providing the enriched first record.

In addition to the above features, the method according to this aspect of the presently disclosed subject matter can include one or more of features (i) to (xliv) listed below, in any desired combination or permutation which is technically possible:
(i) the method further comprising:
e. perform the steps (a) to (d) in respect of at least one additional first record, the at least one additional first record constituting the first record.
(ii) the system is further configured to obtain, from a plurality of first sources, a plurality of first records indicative of a plurality of actual financial transactions,
   a record of the plurality of first records constituting the first record.
(iii) at least one of the following is true:
   A. the second data comprise second records indicative of accounting information associated with the business entity;
   B. the first source(s) is a system associated with one of: a bank, an investment company, a payment service provider (PSP); and
   C. the second source(s) is a system associated with one is one of a general ledger and an enterprise resource planning (ERP) system, associated with the business entity.
(iv) one or more portions of the first record are of a non-fixed format,
   where the performing of the enrichment comprises analyzing the one or more portions of the first record having the non-fixed format.
(v) performing the enrichment comprises:
   I. performing a plurality of enrichment processes,
      where each enrichment process of the plurality of enrichment processes determines an item of added information indicative of the actual financial transaction.
(vi) at least some enrichment processes of the plurality of enrichment processes determine:
(l) at least one of a respective potential counterparty and a respective potential financial classification category, associated with the first record,
   thereby generating a plurality of respective potential counterparties, a plurality of respective potential financial classification categories,
   where the performing of the enrichment further comprises: determining at least the counterparty, and/or at least the financial classification category, based at least on: the plurality of respective potential counterparties and/or on the plurality of respective potential financial classification categories;
(vii) the performing of the enrichment further comprises:
   II. determining one or more confidence scores associated with the counterparty and with the payment classification category.
(viii) in said step (I), the at least some enrichment processes further determine:
(2) at least one respective confidence score associated with the determination, thereby generating a plurality of corresponding respective confidence scores,
where the determining at least the counterparty, and/or at least the financial classification category, of said step (II), is based at least on the plurality of corresponding respective confidence scores.
(ix) the method further comprising:
f. displaying, on a user device, at least the counterparty and/or, the financial classification category, and optionally the confidence scores; and
g. receiving, via the user device, confirmation of the counterparty and/or of the financial classification category.
(x) the performing of the enrichment further comprises:
   III. selecting enrichment processes of the plurality of processes to perform, based on selection criteria.
(xi) the selection criteria are selected from a group comprising:
i. a relevance of a selected enrichment process to the at least one first record;
ii. a relevance of the selected enrichment process to the business entity;
iii. a relative priority of the selected enrichment process;
iv. a dependence of the selected enrichment process on at least one other enrichment process; and
v. configurable rules.
(xii) the enrichment process(es) further performs identification of at least one of:
   i. transfers within subsidiaries of the business entity;
   ii. transfers between of the business entity and a subsidiary; and
   iii. transfers within the business entity.
(xiii) the plurality of enrichment processes perform at least identification of one of the following:
   i. a format of the one or more portions of the first record;
   ii. financial services associated with the first record;
   iii. business entities associated with the first record;
   iv. whether the actual financial transaction is an intercompany transaction;
   v. transaction type;
   vi. deposits;
   vii. withdrawals;
   viii. bank fees;
   ix. income through a financial vendor;
   X. payroll transaction;
   xi. office expenses;
   xii. cloud services expenses;
   xiii. security services expenses;
   xiv. web-related expenses;
   xv. tax payments;
   xvi. social security payments; and
   xvii. software license fees.
(xiv) the method further comprising:
h. identify at least one potentially matching second record, having a potential match with the enriched first record, with an associated matching confidence score;
i. providing the at least one potentially matching second record.
(xv) the method further comprising:
j. perform the steps (k) to (l) in respect of at least one additional first record, the at least one additional first record constituting the first record.
(xvi) the providing comprises displaying, on a user device, information indicative of at least one potentially matching second record, where the method further comprising performing the following:
k. receiving, via the user device, an indication of match confirmation of the potential match.
(xvii) the providing comprises:
1. associating the enriched first record with the highest confidence potentially matching second record.
(xviii) the business entity is one of: a corporation and a partnership.
(xix) the business entity is one of: a parent entity; a subsidiary entity; an affiliated company; and a standalone entity.
(xx) the actual financial transaction is a payment transaction.
(xxi) the payment transaction is associated with at least one of a payment to a business entity via the first source and a payment by the business entity via the first source.
(xxii) the first record(s) is of a non-fixed structure.
(xxiii) at least some of the first records are obtained via an Application Programming Interface.
(xxiv) at least some second data of the second data is received via an Application Programming Interface.
(xxv) records of the second records comprise at least one of the following fields: entity identification information, counterparty identification information, credit memo information, invoice information, and purchase order information.
(xxvi) the accounting information is indicative of at least one of: an accounts payable to be paid, either by the business entity or by another business entity associated with the business entity; and an accounts receivable to be received, either by the business entity or by the other business entity.
(xxvii) the portions(s) of the first record comprises at least one of payment amount, payment date, transaction description, transaction date and time, possess date and time, SWIFT® code, originator bank, and counterparty details (address, phone etc.) and industry.
(xxviii) the financial classification category is indicative of a direction of flow of the payment.
(xxix) the method further comprises storing the enriched record.
(xxx) the method further comprises:
   responsive to adding a new enrichment process to the system, performing again existing enrichment process(es) in respect of the enriched first record(s).
(xxxi) performing the enrichment further comprises performing the plurality of enrichment processes in a particular order, based on dependencies among the plurality of processes.
(xxxii) displaying the confidence score is in a qualitative fashion.
(xxxiii) the displaying is performed when the confidence scores are below a configured level.
(xxxiv) the displaying is performed based on a weighting of the confidence scores and an amount of the payment.
(xxxv) the method further comprising:
m. adding, to the at least one enriched record, information indicative of the one or more portions, based on the analysis.
(xxxvi) the method further comprising:
n. performing a normalization of the first record, thereby generating a normalized enriched first record, wherein the normalization comprises:
   (1) assigning a fixed number of fields to the normalized first record;
   (2) populating one or more fields of the normalized first record; and
   (3) normalizing a format of at least one field of the one or more fields;
   (4) adding a field with a value of the actual financial transaction in a normalized currency.
(xxxvii) the method further comprising:
o. re-training the at least one machine learning model using the enriched first record, thereby obtaining at least one updated machine learning model.
(xxxviii) the steps (II) and (III) are skipped for an enrichment process which did not determine the respective potential counterparty and did not determine the respective potential financial classification category.
(xxxix) at least one enrichment process performs the determination at least partly based on configurable rules.
(xl) each enrichment process is configured to derive an interim or updated enriched first record,
   where another process of the plurality of processes is configured to utilize the interim or updated enriched first record in the determination of at least the counterparty and/or the financial classification category.
(xli) the identifying comprises comparing the enriched first record to a plurality of unreconciled second records, thereby assigning a plurality of match confidence scores to a plurality of matches,
   where the identifying is based on relative values of the plurality of match confidence scores.
(xlii) the associating comprises at least partly reconciling at least one second record of the second records, based on the enriched first record.
(xliii) the identifying comprising:
   i. deriving a plurality of first data tokens based on first parameters of the first record;
   ii. deriving a plurality of second data tokens based on second parameters of the at least one potentially matching second record;
   iii. running reconciliation machine learning models, which: iii.
      (a) compare the plurality of first data tokens with the plurality of second data tokens;
      (b) determining the potential match, based at least on the comparison; and
      (c) assign a match confidence score to the potential match.
(xliv) the associating comprises:
   responsive to a change in the at least one machine learning model, performing the following:
      (a) performing another run of the at least one machine learning models, thereby identifying at least one other potentially matching second record having a second potential match with the enriched first record;
      (b) assigning a second match confidence score to the second potential match;
      (c) responsive to the match not being associated with the indication of match confirmation via the user device, performing a second association, between the enriched first record and the at least one other potentially matching second record; and
      (d) responsive to the match being associated with the indication of confirmation via the user device, performing the following:
         i. alerting, via the user device, about the second potential match;
         ii. receiving, via the user device, an indication to perform the second association; and
         iii. performing the second association.

According to a second aspect of the presently disclosed subject matter there is presented a system configured to provide data pertaining to a record, comprising a processing circuitry, the processing circuitry configured to perform the following method:
a. obtain, from at least one first source, a first record indicative of an actual financial transaction, paid via the first source;
b. perform enrichment on the first record, thereby determining at least one of: a counterparty associated with the first record; and a financial classification category associated with the first record,
wherein the performing of the enrichment utilizes at least one machine learning model trained to identify correspondence, of first records indicative of actual financial transactions associated with a business entity, to second data,
wherein the second data are obtained from at least one second source, distinct from the at least one first source;
c. derive an enriched first record, based on the enrichment; and
d. provide the enriched first record.

According to a third aspect of the presently disclosed subject matter there is presented a non-transitory computer readable storage medium tangibly embodying a program of instructions that, when executed by a processing circuitry of a system a record, cause the processing circuitry to perform a method of providing data pertaining to a record, the method comprising:
a. obtaining, from at least one first source, a first record indicative of an actual financial transaction, paid via the first source;
b. performing enrichment on the first record, thereby determining at least one of: a counterparty associated with the first record; and a financial classification category associated with the first record,
wherein the performing of the enrichment utilizes at least one machine learning model trained to identify correspondence, of first records indicative of actual financial transactions associated with a business entity, to second data,
wherein the second data are obtained from at least one second source, distinct from the at least one first source;
c. deriving an enriched first record, based on the enrichment; and
d. providing the enriched first record.

The second and third aspects of the disclosed subject matter can optionally include second to third aspects of the presently disclosed subject matter can include one or more of features (i) to (xliv) listed above, in any desired combination or permutation which is technically possible.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 schematically illustrates an example generalized view of a system for data handling, in accordance with some embodiments of the presently disclosed subject matter;

FIG. 2 schematically illustrates an example conceptual diagram of layers of functionality, in accordance with some embodiments of the presently disclosed subject matter;

FIG. 3 schematically illustrates an example generalized schematic diagram of modules of a processor, in accordance with some embodiments of the presently disclosed subject matter;

FIG. 4 schematically illustrates an example generalized schematic diagram of a memory, in accordance with some embodiments of the presently disclosed subject matter;

FIG. 5 schematically illustrates an example generalized schematic diagram of a data store, in accordance with some embodiments of the presently disclosed subject matter;

FIG. 6 schematically illustrates an example generalized schematic diagram of enricher interactions, in accordance with some embodiments of the presently disclosed subject matter;

FIGS. 7A and 7B schematically illustrates an example generalized schematic diagram 700 of enricher hierarchy, in accordance with some embodiments of the presently disclosed subject matter;

FIGS. 8A-8D schematically illustrate a generalized flow chart diagram, of a process flow, in accordance with some embodiments of the presently disclosed subject matter; and

FIGS. 9A-9D schematically illustrate a generalized flow chart diagram, of a process flow, in accordance with some embodiments of the presently disclosed subject matter.

### DETAILED DESCRIPTION

In the drawings and descriptions set forth, identical reference numerals indicate those components that are common to different embodiments or configurations.

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

Unless specifically stated otherwise, as apparent from the following discussions, it is appreciated that throughout the specification discussions utilizing terms such as “obtaining”, “providing”, “receiving”, “performing”, “deriving”, “generating”, “determining”, “analyzing”, “selecting”, “adding”, “classifying”, “identifying”, “computing”, “displaying”, “training”, or the like, refer to the action(s) and/or process(es) of a computer that manipulate and/or transform data into other data, said data represented as physical, e.g. such as electronic or mechanical quantities, and/or said data representing the physical objects. The term “computer” should be expansively construed to cover any kind of hardware-based electronic device with data processing capabilities including a personal computer, a server, a computing system, a communication device, a processor or processing unit (e.g. digital signal processor (DSP), a microcontroller, a microprocessor, a field programmable gate array (FPGA), an application specific integrated circuit (ASIC), etc.), and any other electronic computing device, including, by way of non-limiting example, computerized systems or devices 110 and processing circuitries such as e.g. 120 disclosed in the present application.

The operations in accordance with the teachings herein may be performed by a computer specially constructed for the desired purposes, or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

The terms “non-transitory memory” and “non-transitory storage medium” used herein should be expansively construed to cover any volatile or non-volatile computer memory suitable to the presently disclosed subject matter.

As used herein, the phrase “for example,” “such as”, “for instance” and variants thereof describe non-limiting embodiments of the presently disclosed subject matter. Reference in the specification to “one case”, “some cases”, “other cases”, “one example”, “some examples”, “other examples”, or variants thereof, means that a particular described method, procedure, component, structure, feature or characteristic described in connection with the embodiment(s) is included in at least one embodiment of the presently disclosed subject matter, but not necessarily in all embodiments. The appearance of the same term does not necessarily refer to the same embodiment(s) or example(s).

Usage of conditional language, such as “may”, “might”, or variants thereof, should be construed as conveying, that one or more examples of the subject matter may include, while one or more other examples of the subject matter may not necessarily include, certain methods, procedures, components and features. Thus, such conditional language is not generally intended to imply that a particular described method, procedure, component or circuit is necessarily included in all examples of the subject matter. Moreover, the usage of non-conditional language does not necessarily imply that a particular described method, procedure, component or circuit is necessarily included in all examples of the subject matter.

It is appreciated that certain embodiments, methods, procedures, components or features of the presently disclosed subject matter, which are, for clarity, described in the context of separate embodiments or examples, may also be provided in combination in a single embodiment or examples. Conversely, various embodiments, methods, procedures, components or features of the presently disclosed subject matter, which are, for brevity, described in the context of a single embodiment, may also be provided separately or in any suitable sub-combination.

It should also be noted that each of the figures herein, and the text discussion of each figure, describe one aspect of the presently disclosed subject matter in an informative manner only, by way of non-limiting example, for clarity of explanation only. It will be understood that the teachings of the presently disclosed subject matter are not bound by what is described with reference to any of the figures or described in other documents referenced in this application.

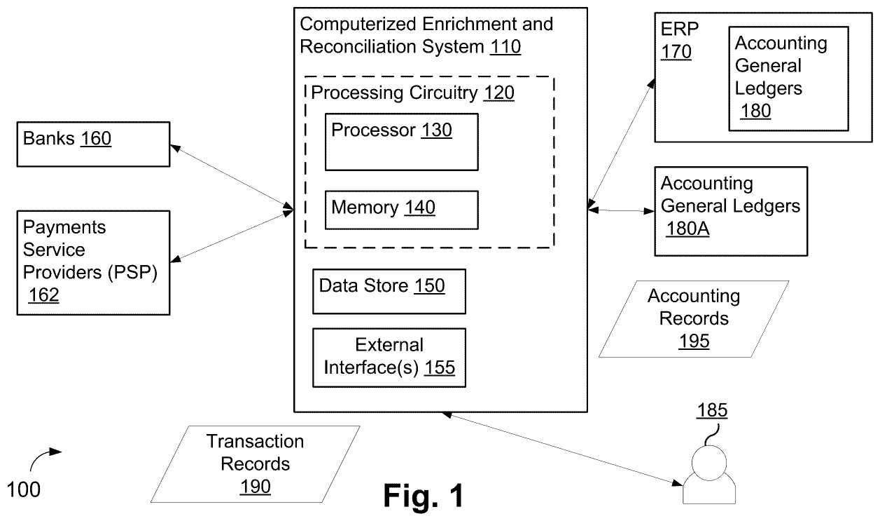

Bearing this in mind, attention is drawn to FIG. 1, schematically illustrating an example generalized view of a system for data handling, in accordance with some embodiments of the presently disclosed subject matter. View 100 depicts a conceptual and schematic example view of a computerized enrichment and reconciliation system 110, and example external interfaces. The rectangles denote associated systems and components, while the parallelograms indicate input items.

In some non-limiting examples, computerized system 110 includes a computer. It may, by way of non-limiting example, comprise a processing circuitry 120. This processing circuitry may comprise a processor 130 and a memory 140.

This processing circuitry 120 may be, in non-limiting examples, general-purpose computer(s) specially configured for the desired purpose by a computer program stored in a non-transitory computer-readable storage medium. They may be configured to execute several functional modules in accordance with computer-readable instructions. In other non-limiting examples, this processing circuitry 120 may be a computer(s) specially constructed for the desired purposes.

In some examples, processor(s) 130 of processing circuitry 320 can run various functional modules. Non-limiting examples of such modules are disclosed further herein with reference to FIG. 5.

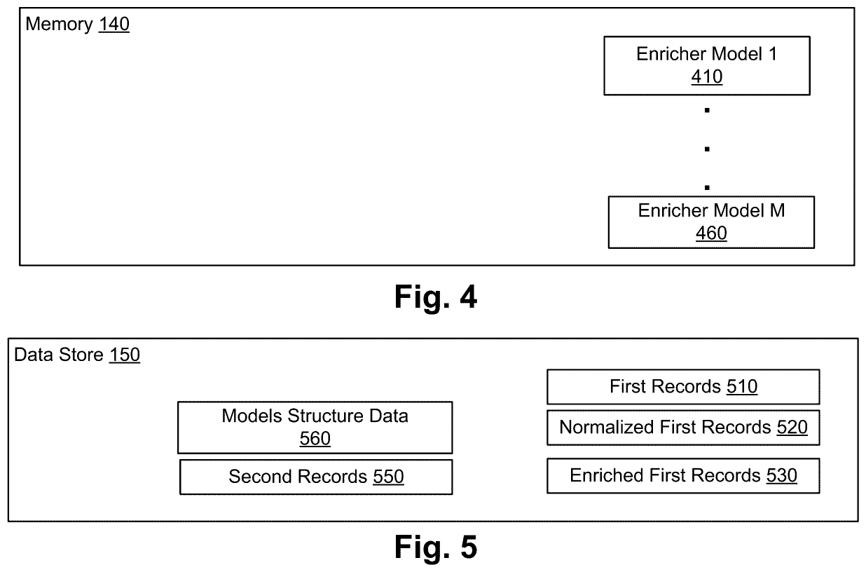

In some examples, memory 140 of processing circuitry 120 is configured to store data associated with the enrichment process, e.g. comparatively transitory data. Non-limiting examples of data stored in memory 140 are disclosed further herein with reference to FIG. 4.

In some examples, enrichment and reconciliation system 110 comprises data store 150. In some examples, more long-term and persistent data is stored in the data store. Non-limiting examples of data stored in data store 150 are disclosed further herein with reference to FIG. 5.

In some examples, system 110 comprises one or more external interfaces 155, each used to provide connection between the system and the corresponding external systems/users shown in the figure.

Consider a business entity such as a corporation or a partnership, for example. The business entity performs financial transactions, via various external systems. Examples include payment transactions-receiving payment from another entity or organization, or and/or sending payment to the entity. Examples of external systems via which such transactions are performed include one or more systems 160 associated with or belonging to one or more banks. Consider, in a simplified example, a company A which makes payments to another company B, and which receives payments from company C (and/or B). Company A uses banks 160 X and Y. In some examples, the enrichment system 110 is configured with the information details of company A, and with the bank names and identification information of the relevant banks X and Y, as well as the relevant account numbers and account names etc. of the business entity (including at which bank the particular account resides). The bank system(s) 160 of e.g. bank X is configured such that system 110 has permissions to access the system 160, to have access to records associated with the relevant defined accounts associated with company A. These permissions are e.g. defined at the request of company A, since system 110 is in effect acting in the company's name when they obtain the records. In such a manner, system 110 is configured to obtain the relevant financial transaction records from system 160.

In some examples, the records are pushed to system 110. In other examples, the records are pulled by system 110 from system 160. In some examples, the transfer is directly between the two system 110 and 160. In others, there is an intermediate system or storage (not shown), e.g. system 160 writing to an intermediate storage and system 110 pulling from that same storage. The above are only non-limiting examples—the obtaining of the records can be done in any manner, e.g. per known per se methods.

Another example type of payment transaction of interest is payment of taxes (and refund of taxes) between company A's bank(s) and the systems of various government authorities—income tax authorities, social security authorities, VAT/purchase tax authorities, customs authorities etc.—as distinguished from payments between company A and another corporate entity D.

Note that payment transactions are only one type of financial transaction, the records of which system 110 is configured to obtain. Another non-limiting example of a financial transaction is a move between two accounts of company A, or between two sub-accounts of an account. One example of this is movement between a checking account and a deposit account, or other type of savings account or instrument, defined under company A's account. Such a transaction is not necessarily a “payment” between company A and another business entity.

Another type of transaction to be captured by system 110 includes, for example, a payment of fees (monthly and/or per certain transactions), out of company A's bank account to the bank itself. This might strictly be seen not as a “payment”, in conventional terms, and thus the financial transactions obtained by system 110 can be more generally referred to herein, in some examples, as money-transfer transactions. Another example transaction is currency exchange from currency X to currency Y.

Note also that the financial transactions, the records of which are obtained by system 110, are not necessarily bank transactions. In some examples, the system 110 obtains financial transaction records from an investment company (not shown), e.g. a brokerage, a mutual fund company, a pension fund etc. In some other examples, system 110 obtains financial transaction records from a payment service provider (PSP). A non-limiting example of a PSP is a credit card company, PayPal® etc.

These systems, exemplified by banks 160 and PSPs 162 are referred to herein as first sources 160, 162, for ease of exposition, to distinguish them from second sources, which are disclosed further herein with reference to this figure. Also, purely for ease of exposition, the system(s) 160 of banks(s), and the system(s) 162 of PSPs etc. are referred to herein also simply as “banks 160”, “PSPs 162” etc.

In some examples, at least some of the first records are received, or otherwise obtained, via an Application Programming Interface (API).

Note that in some non-limiting examples, the financial transaction is associated with a payment to a business entity (e.g. company A) via the first source 160, 162, e.g. to another entity such as company D, and a payment by the business entity via the first source, e.g. from the other entity.

These transactions are referred to herein as actual financial transactions (or as “financial transactions”, in short), in the sense that actual movement of money occurs into, or out of, first sources, or e.g. between different accounts or sub-accounts within a first source. This terminology is used, to distinguish the transactions of interest (e.g. payments to/from the entity, interest/fee payments paid to the entity's account from the bank or vice versa etc.), in the presently disclosed subject matter, from such financial transactions as e.g. recording in a company's books that a certain depreciation has been applied e.g. to a certain asset. Such a depreciation event or transaction, for example, will appear in the accounting system only, not in the records of e.g. a bank or credit card company.

In some examples, the actual financial transactions can be referred to as cash transactions. However, in many cases there is no cash involved.

Note that the business entity is in some examples a related company/entity of another entity. For example, the business entity is a parent entity, e.g. a parent corporation. In some other examples, the business entity is a subsidiary entity, e.g. a corporation that is a subsidiary of a parent corporation. In still other examples, the business entity is an affiliated company of another company, but not strictly either a parent or a subsidiary. Another example is movement between two accounts of the same entity, whether in the same bank or in different banks. In still other examples, the business entity is a standalone business entity, having no affiliation or other relationship with another business entity, e.g. not being part of a larger group.

In order to, address, inter alia, at least certain issues, challenges and/or problems disclosed further herein, and to provide at least certain corresponding example technical advantages, the presently disclosed subject matter discloses a computerized method, configured to provide data pertaining to a record, as well as a computerized system 110 and software products configured to perform such a method.

The method comprises, in some examples, the following:
(a) obtaining, from one or more first sources, a first record indicative of an actual financial transaction, paid via the first source;
(b) performing enrichment on the first record, thereby determining at least one of: a counterparty associated with the first record; and a financial classification category associated with the first record. The performing of the enrichment in some examples utilizes at least one machine learning model, trained to identify correspondence, of first records indicative of actual financial transactions associated with a business entity, to second data. The second data are obtained from at least one second source, which is distinct from the at least one first source;
(c) deriving an enriched first record, based on the enrichment; and
(d) providing the enriched first record.

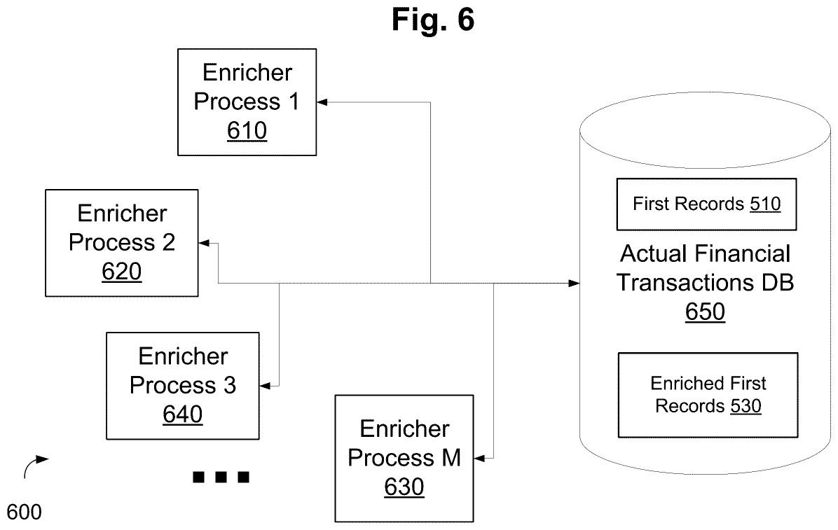

Details of the enrichment method are disclosed further herein, including with reference to FIGS. 6 to 8.

Note that the term “record” in the presently disclosed subject matter includes data indicative of a record, rather than a record per se. In some examples, the system 100 instead receives, more generally, data indicative of an actual financial transaction.

Two other terms referred to further herein are “counterparty” and “intercompany”. In some examples, the counterparty is the party or entity associated with the actual financial transaction, which is not the business entity. Thus, per the above example, company A is the business entity, and the system 110 is configured to obtain records or other financial transaction data from e.g. banks 160. Assuming that the record is of a payment made by company A, the counterparty, company D, is e.g. the entity to which the payment was made. Similarly, for a record of a payment received by A, the counterparty is the entity (e.g. D) from which the payment was made to A. As other non-limiting examples, in a case of e.g. salary payments, the counterparty can be the name of a particular employee, John Doe, or instead a general party such as “the company's employees”. The type of counterparty in some examples depends on the resolution level at which the company A wants to know, analyze and understand this particular type information.

For taxes, the counterparty could be e.g. “the income tax authority”, “the customs authority” etc.

Regarding the term “intercompany”, in some examples the computerized system 110 is configured with the corporate/business structure of the business entity. For example, Company A has a number of subsidiaries and affiliates, and some of these subsidiaries in turn have subsidiaries, and so on. The system 110 is configured to understand the “tree” of ownership and association of the entity. The system is also, in some cases, configured to know the account numbers and names (e.g. of a bank, a credit card etc.), associated with each sub-entity within the overall entity structure. Intercompany, in the presently disclosed subject matter, refers, in one example, to an actual financial transaction between accounts of two entities (or sub-entities) within the business entity, e.g. between Company A and its subsidiary Company E, e.g. between two companies within a company. For example, based on the account number and/or account name of the counterparty, the transaction is determined to be intercompany.

In another example of intercompany, the transaction is between two accounts (e.g. two bank accounts) of a single account, or between two sub-accounts within a single account in a bank (e.g. between a cash/checking account and a deposit account such as a Certificate of Deposit) of the same entity—or between two accounts of the same entity at two different first sources, e.g. two different banks or PSPs. Another example of a transfer within the same business entity is a transfer between two different currencies in the same account.

In some examples, e.g. in the records generated by certain banks, the transaction is actually marked as “intercompany”. In other examples, e.g. for other banks, this information does not appear in the transaction data. However, using methods such as those disclosed further herein, the system 110 is in some implementations configured to identify that a particular transaction was between account number ABC of bank X and account number DEF of bank Y. The system knows (e.g. by configuration) that account ABC belongs to company A, and that account DEF belongs to its subsidiary company E. The system thus can “label” or otherwise identify that this should be classified as an intercompany transaction.

As indicated in the above summary, in some examples the enrichment process yields identification of financial classification categories associated with the particular transaction-related record. These financial classification categories are categories defined by the relevant business entity A as having business importance, for e.g. analysis to be performed on the records and enable useful business applications and/or insights. For example, the categories may be useful for the relevant people in the entity to build a budget, to manage cash, to create a plan of work etc. Various examples of financial classification categories are disclosed throughout the present application. In one non-limiting example, the financial classification category is indicative of a direction of flow of the payment—for example, whether the financial transaction is an expense or income, or is a receivable or payable (e.g. “accounts receivable” or “accounts payable”).

In some examples, particular parameters can be considered to be the same category, or different categories, depending on the needs of the relevant business entity. As one example, looking at salary transactions, one company wants to distinguish salary of full-time vs part time workers as two different categories, while another company considers them as a single category. In some examples, these definitions can be configured per business entity. In some examples, the system provides a set of generic categories, and the system is configured to let the user business entities map them to their own categories. For example, the system provides three separate salary financial classification categories for American, Asian and European workers, and company A maps all three to a single “Salary” financial classification category.

In some examples, the financial classification category is indicative of a service or product provided. For example, it can categorize a particular transaction as payment for the service of rent, another as payment for consultation services, and a third transaction as payment for office supplies.

In another example, the system performs identification of transfers within subsidiaries of a particular business entity. This is defined, in some examples, as the financial classification category “intercompany”. In other examples, the intercompany category is more general, and includes transfers between affiliates, subsidiaries or other entities associated with the relevant business entity. That is, the classification is based on the transaction being determined to be one that is between a particular business entity and another business entity associated with that business entity.

Note that the ability to identify transactions as intercompany can in some cases have great impact on, for example, the example of business processes. If, for example, company A is measuring its cash flow situation, and it does not correctly interpret a payment to company E as simply an intercompany transaction between a parent and its child company, various erroneous alerts might be flagged about a cash flow problem, and various actions triggered (e.g. automated selling of a deposit or security to raise cash) when they should not be. Thus, for example, erroneous and problematic actions and behaviors of the system 110, and of related systems, can be avoided.

As disclosed above, in some examples the system 110 derives an enriched first record, based on the enrichment. In some implementation, the generated replaces, modifies and/or overwrites the original first record of the actual financial transaction. Alternatively, the enriched first record can be a different record. After generating this additional record, in some examples the system deletes the original first record. In other examples, the original record is not affected, and two records exists for this transaction. In still other examples, the system links the original and the enriched first records, and we it can even store each in different data areas.

In some examples, system 110 then provides the enriched first record. Examples of providing include storing the record into a database or other storage, presenting to a human user 185 (e.g. via a GUI), using the record for machine learning model training, sending it to another system etc.

In some examples, the above method further comprises:
(e) perform the steps (a) to (d) in respect of at least one additional first record.

That is, the system enriches multiple actual financial transaction records associated with the business entity.

The enrichment process for transaction records, in some cases, has at least some example technical advantages. In some examples, one or more portions of the first record are of a non-fixed format, that is a varying format, e.g. a non-fixed structure. In bank transaction records, the fields are often not populated in a fixed way. For example, the counterparty name might appear in a contracted or truncated format, the dates may sometimes appear as “180524”, in others as “May 18 '24”, and in others as “May 18, 2024”, etc. Many existing automated systems are not capable of dealing with these variations, thus are not able to understand the values of the fields or parameters in the received records, and thus are not able to characterize the transaction represented by the received input data from the bank etc.

In such a case, in some implementations, performing the enrichment comprises analyzing these portions of the first record having the non-fixed format. In some examples, an entire field in the records has non-fixed format. In others, a portion of a field has non-fixed format. In some examples, such portions or fields of the first record comprise at least one of payment amount, transaction date and time, possess date and time, payment date, transaction description, country code, counterparty information and industry. Other example fields which can have non-fixed formats include: SWIFT® code, originator bank name, and counterparty details (address, phone etc.) and counterparty industry, transaction status (e.g. pending or final, for a credit card or bank transaction).

Other example fields in a transaction first record include transaction date and time (creation/initiation of the transaction), possess date and time (the time that the transaction was processed, and the money actually arrived at the destination), and SWIFT® code.

The system 110 is configured to enrich ether records, and thereby e.g. determine counterparty and financial classification categories, even in cases of a problematic-format input, i.e. where the formats of various information items are varying and/or are not known a priori.

In some examples, the above method further comprises:
(f) adding, to the enriched record(s), information indicative of the one or more portions, based on the analysis of the portion(s) of the first record that have a non-fixed format.

As one example, the received bank record includes the unclear text string “JonDoC”. After the machine-learning based enrichment process, the system determines that this field in fact refers to “John Doe Co.”, and that it in fact refers to the counterparty of the transaction. The system has determined these previously unknown parameters of the first record.

The system adds these two pieces of information to this first record, and thus derives from the record an enriched first record. The system further determines, based on various other information analyzed, that the transaction refers to a received payment for rent, and adds to the enriched record the two financial classification categories “received payment/accounts receivable” and “payment for rent”.

In one example, a counterparty such as “John Doe Co.” is determined based on a similarity to business entities that appear e.g. on ledger 180, 180A, the entries of which should generally include a counterparty. Thus, no “JonDoC” exists in ledger records, but the system determines that it is most similar to “John Doe Co.”, and it determines that that counterparty is intended (the differences being e.g. due to typos in data entry, due to contractions used etc.)

Tables 1 to 4 discloses examples of the fields in a “raw” received first record of an actual financial transaction, received from a bank; and of the fields of enriched first record, which identifies unclear information in the raw record and which adds other information determined by the enrichment. Comments in the table indicate how some of the enrichment can be derived.

TABLE 1

| Received First Record | Enriched First Record |
|---|---|
| datetime: “Nov. 10, 2023 | datetime: Nov. 10, 2023 6:07 AM (convert |
| 11:07 AM” | to UTC using the bank time zone) |
| description: | Link to an invoice number INV203539 |
| “INV20 3539 amount = | (the blank space is a typo) in the ERP |
| 2690 USD” | |
| | Counterparty: ABC holdings |
| | (incorporating ERP data of counterparty, |
| | using the invoice number) |
| | Counterparty address: 360 34 Ave NYC |
| | Counterparty country = USA |
| | Counterparty state = NY |
| | Counterparty typical payment = 4500 |
| | USD |
| | category: inflow |
| | Invoice Amount = 2690 USD |
| amount: | Amount = 2675 USD. |
| “2675 USD” | |
| | Counterparty fees = 15 USD [=2790 − |
| | 2775] [Note: ABC still owes the entity 15 |
| | USD. The entity can decide to keep the |
| | invoice open, or to forgive the amount. |
| | Could e.g. present these options at the |
| | reconciliation stage. Or the policy for |
| | these cases could be automated.] |

TABLE 2

| Received First Record | Enriched First Record |
|---|---|
| Description: “transfer 10000 | Account Number: 362191908 |
| USD to account 362191908” | |
| | Counterparty: XY communication. |
| | (The account belongs to a sister company |
| | named XY communication |
| | (Based on account number) |
| | Counterparty address: 430 Washington |
| | Blvd, Seattle, Washington |
| | Counterparty country = USA |
| | Counterparty state = WA |
| | Category: intercompany |
| Amount: | Amount = 10,012 USD. |
| “10012 USD” | (Out of it, 12 USD are fees, and 10,000 |
| | USD are the actual intercompany transfer) |

TABLE 3

| Received First Record | Enriched First Record |
|---|---|
| Description: | (There are several transactions packed as |
| “bulk transfer id 831A562” | one bulk transaction. Using an external |
| | source the list of transactions for this ID |
| | 831A562 is found. It translates into |
| | several transactions (possibly with several |
| | categories), e.g. deposit of multiple |
| | checks, payment of multiple salaries, each |
| | of which could be analyzed.) |

TABLE 4

| Received First Record | Enriched First Record |
|---|---|
| . . . | (various fields about amount and |
| | transaction time) |
| Description: | Counterparty Name = John Doe Co. |
| “JnDoCo ABC9876” | (Based on similarity to a name in ERP) |
| | Counterparty Street Address = |
| | 345 Main Street (based on ERP record for |
| | this counterparty) |
| | Counterparty City = Paris |
| | Counterparty Country = France |
| | Transaction direction - received payment |
| | Transaction business category - received |
| | rent |
| | Transaction frequency - repeated monthly |
| | payment |
| | Institution Type = Bank |
| | Institution Name = ABC National Bank |
| | Account Name = XYZXYZ Ltd. |
| | Account Number = 9876 |
| | Account Currency = USD |

Note that, in some cases, enrichment of first records for payments sent by the business entity is easier than enrichment of those records for payments received by the entity. If, for example, Company A issued a payment to a supplier of theirs, their accounting and/or other internal records are likely to have information that a payment of a certain amount was initiated at a certain date and time, to a certain other bank account—as compared to a case where an incoming payment is received at the company's bank 160 account on a certain date, with little information attached. Since Company A has no control over what money arrives, how much, when, and from where, the company may have less a priori readily available information with which to definitively identify the nature of the incoming payment and to characterize it.

Another non-limiting example of an enrichment is handling pending transactions. Consider a case in which the bank sends on one day the state of a particular account, including transactions with status “pending”, and on the next day the bank sends the state of the account, with the pending transaction not present. In some cases, it has been replaced by a transaction with status “final”, while in others the transaction no longer appears at all. It can be that the final and pending transactions do not share the same transaction ID, and there is no connection between the two first records. Enrichment can determine that the two transactions in fact refer to the same transaction, and it can in some cases link them in some fashion. The system, in some examples, analyzes the pending transactions, and can enrich them by adding a field with the predicted final status.

This can be useful, for example, to enable the business entity to have a clear and accurate picture of its financial state at any point. Consider a case in which the bank on Day 1 has a certain balance in the bank, and the entity wants to determine how much it can safely put into a long-term deposit. Based on the predicted final status, provided by the enrichment, the entity has a clear picture of which pending transactions will go through, and when, thus facilitating a more accurate picture of the entity's cash status at this point in time.

In some examples, system 110 is configured to obtain, from a plurality of first sources, a plurality of first records indicative of a plurality of actual financial transactions, associated with the business entity.

This functionality provides at least certain example technical advantage. Many existing systems, which process actual financial transactions, are not configured to, and do not, connect or otherwise communicate with multiple financial institutions, e.g. with multiple banks, or a bank and PSP. For example, such systems cannot connect with an API to all banks, including both local and foreign/overseas banks. Those systems might have to e.g. enter as a bot, and get data from each.

Also, across multiple institutions, in some cases the same fields (e.g. account name) have different names and formats. Many existing systems are not configured to understand the format of the data of each of the required banks. Other examples include the “memo” filed, called by some banks “note” or “label”; the transaction date, called by some banks “value_date”, “processed” or “create bank_date”; and the status field, where “pending” is called by some banks “sent”.

Such prior art systems thus cannot have a full picture of the business entity's transactions, or at least cannot have this picture in near real time. Often, it takes days to combine the information from multiple institutions, if this can be done at all, thus providing the enriched records, and enabling the running of applications, and obtaining of insights, which make use of the enrichment, only at a relatively large delay-one which may adversely affect the entity's business processes.

By contrast, the presently disclosed subject matter in some examples enables the system 110 to obtain all of the relevant payment/financial transactions information, from many or all of the required financial institutions, of various types (Banks, PSPs etc.) in near real time, thus providing enriched data and a clear picture of the company's situation in a timely manner. System 110 is configured, inter alia, to handle and understand the different formats.

Reverting to the record enrichment method, it in some examples utilizes at least one machine learning model. The model has been trained to identify correspondence, of previously received first records, which are indicative of actual financial transactions associated with a business entity, to second data. The second data are obtained from one or more second sources 185, 170, 180A, which are distinct from the first source(s) 160, 162. Two non-limiting examples of second data are now disclosed.

In one example, the model is trained using human labels associated with the first records. A human user 185, using the user interface a terminal or other computer (not shown, for simplicity), does e.g. a visual inspection of first records of transactions, identifies the relevant information, and applies labels. For example, they figure out what the date is, and enters it in a standard format. In another example, they review a field containing multiple parameters, e.g. account number and an abbreviated account name, and enter each separately, while spelling out the full account name. In another example, they identify the counterparty. The model is trained on the labeled first records. The trained model is used to derive the relevant enrichment information also for newly received first records that are input to the trained model.

In a second example, a human labeler is not needed. The first records of financial transactions are compared to a different type of record, coming from a different source. In some example implementations, the second data comprise second records 195 indicative of accounting information associated with the same business entity. In some example implementations, the second source(s) is a system associated with one of a general ledger 180, 180A and an enterprise resource planning (ERP) system 170, which are associated with a particular business entity. In the figure, two example implementations are shown. In one, an ERP system, in addition to containing other information associated with company A (e.g. data for inventory, materials management, and customer service functions), also comprises company A's general ledger 180. In another, the general ledger resides on a computer or other system 180A that is not within an ERP system, or it runs in a different software within the same computer. In some examples, the business entity's accounting ledger is part of their general ledger. The ledger is sometimes referred to as the entity's “books”. In some implementations, at least some of the second data is received from the second source(s) via an Application Programming Interface (not shown). In some cases, this can be the same API as that used for the first records of actual financial transactions. In others, it is a second, different, API.

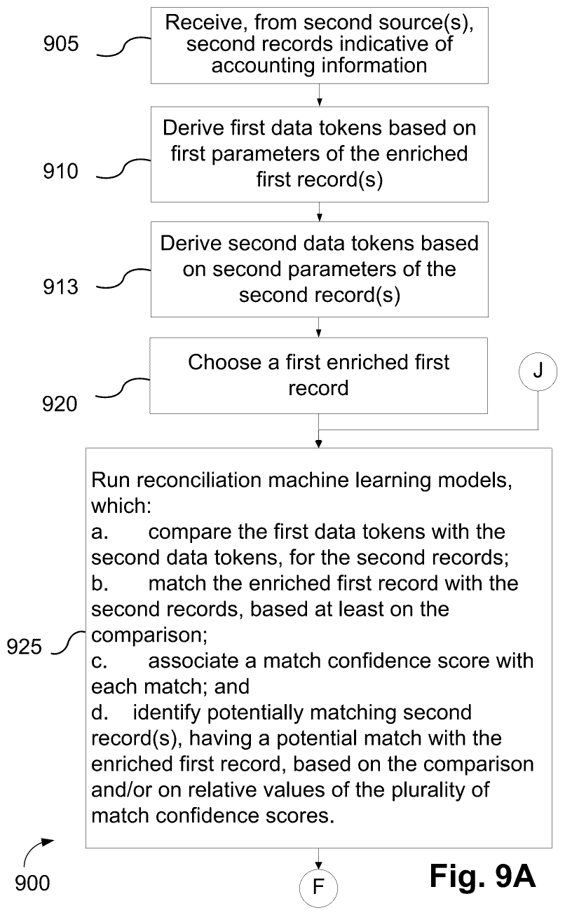

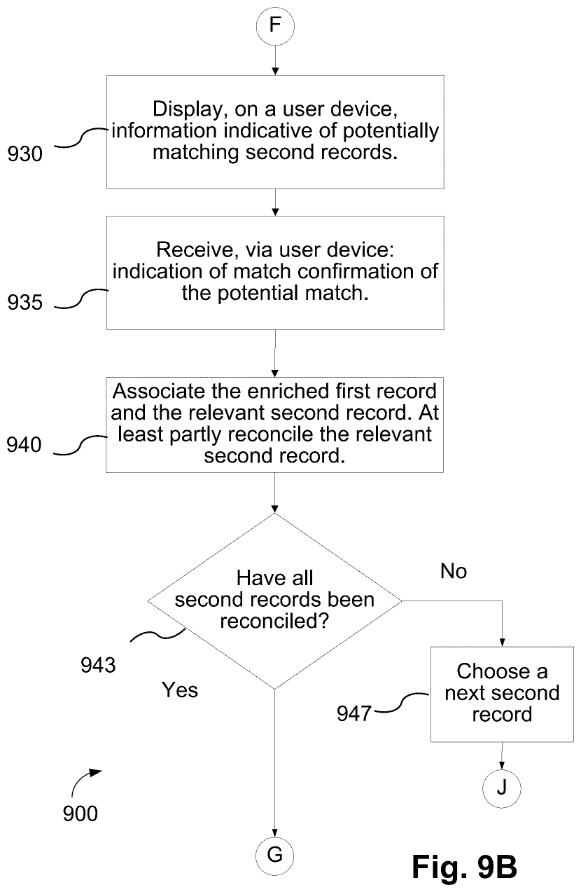

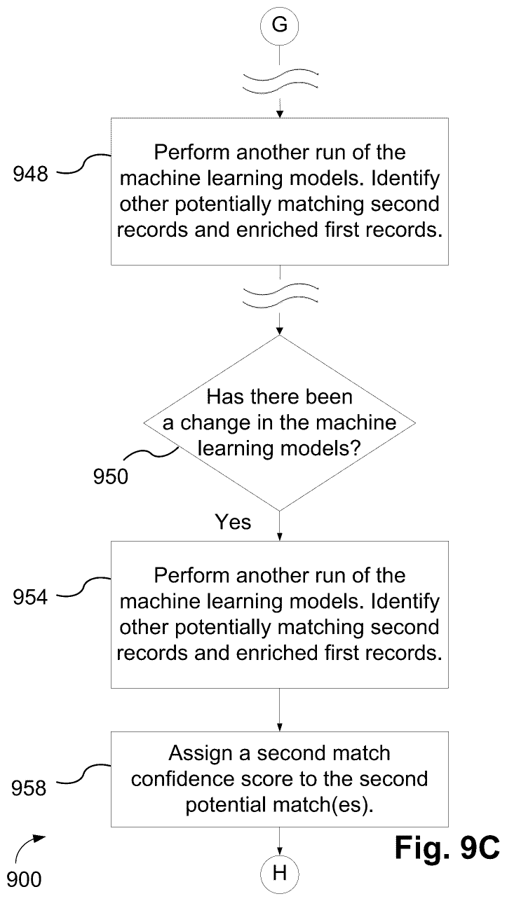

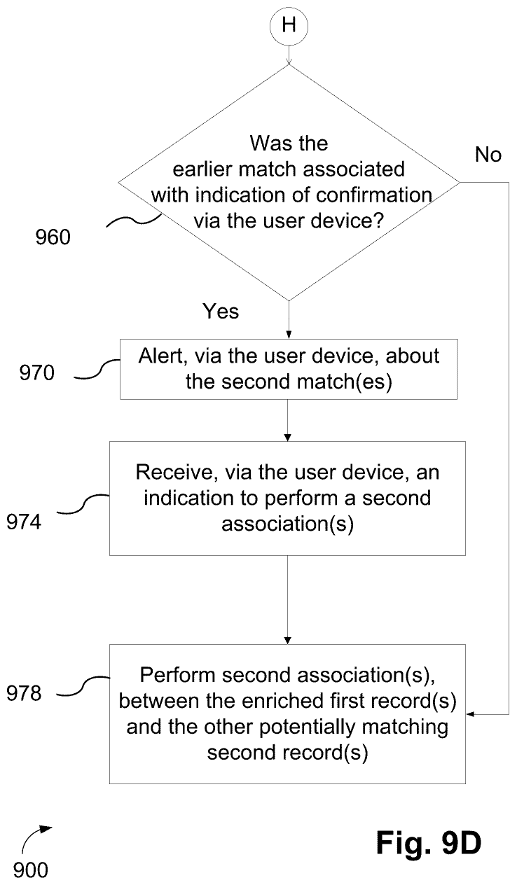

Note that, in the first implementation disclosed above, where a human user 185 is used to label first records 190, the ERP 170, 180 and/or accounting ledger 180A might not strictly be needed in the architecture, in order to enable enrichment. However, in such a case there might still be value to system 110 having connectivity to them, e.g. in order to enable the reconciliation application disclosed further herein with reference to FIG. 9.

Note that systems that handle bank/PSP transactions (first records) typically do not interface also to accounting information sources such as ERP, which are typically separate and distinct systems. The connectivity to the distinct first and second sources, which are sources of different characters, and the ability to handle the various protocols associated with each of the systems disclosed, can enable comparison of records of the two data types (actual financial transactions 190 and accounting information 195), thereby facilitating enrichment of the financial transaction records. Note that the accounting data is typically in a more fixed and complete format than are those of bank and PSP etc. records 190. Moreover, there is typically only one accounting system 170, 180A, associated with a particular business entity, while there typically multiple banks and PSPs, associated with that entity, having not having a standard format between them. Thus, the information in the second data 195 can be used to enrich the first records. In at least such a sense, the enrichment method can identify and characterize the actual financial transaction data 190 based on accounting information 195.

In some examples, at least some of the second records 195 comprise at least one of the following information, e.g. located in fields of the record: entity identification information (e.g. name of the company for whom the records are being processed, or of a subsidiary of it), counterparty identification information, credit memo information, invoice information, and purchase order information.

In some cases, the accounting information is indicative of at least one of: an accounts payable to be paid, either by the business entity (e.g. Company A) or by another business entity associated with the business entity; and an accounts receivable to be received, either by the business entity or by the other business entity. “Accounts payable” is typically a comparatively large category, with typically a number of associated sub-categories, e.g. payroll, tax, office expenses, management fees, travel, marketing expenses, sales commissions. These sub-categories can provide more detailed enrichment than merely “accounts payable”.

By contrast, “accounts receivable” often has fewer sub-categories, typically associated with the lines of business/services/products provided by the entity.

In some examples, the accounting information 195 is indicative of a past and/or a future payment or other transaction.

As was indicated above, the machine learning model(s) trained to identify correspondence of the first records 190 to the second data 195. In some examples, correspondence comprises matching records, e.g. determining that first records of certain appearance and content tend to be associated with certain types of accounting records. For example, the model has learned that bank transactions with certain characteristics, e.g. of a particular entity (or perhaps across multiple or all entities), typically are associated with purchase orders for office supplies, and this knowledge can be used to enrich a new incoming bank record. In some other examples, the correspondence can be of a different nature—e.g. that a financial transaction and an accounting record are NOT matched. For example, certain cash transactions that always occur in the middle of the month are determined by the model to not be associated with certain accounting transactions/records that always occur on the first of the month. These two are only illustrative examples of correspondence.

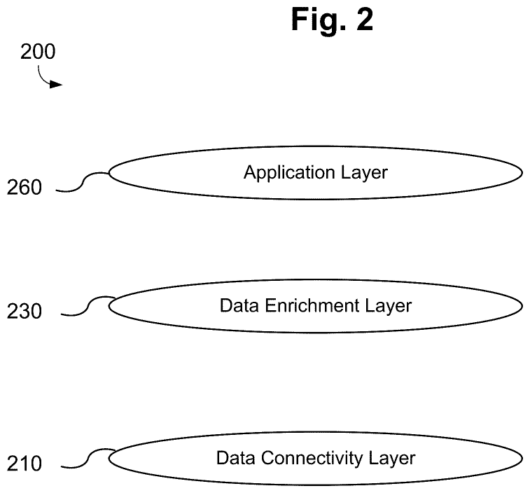

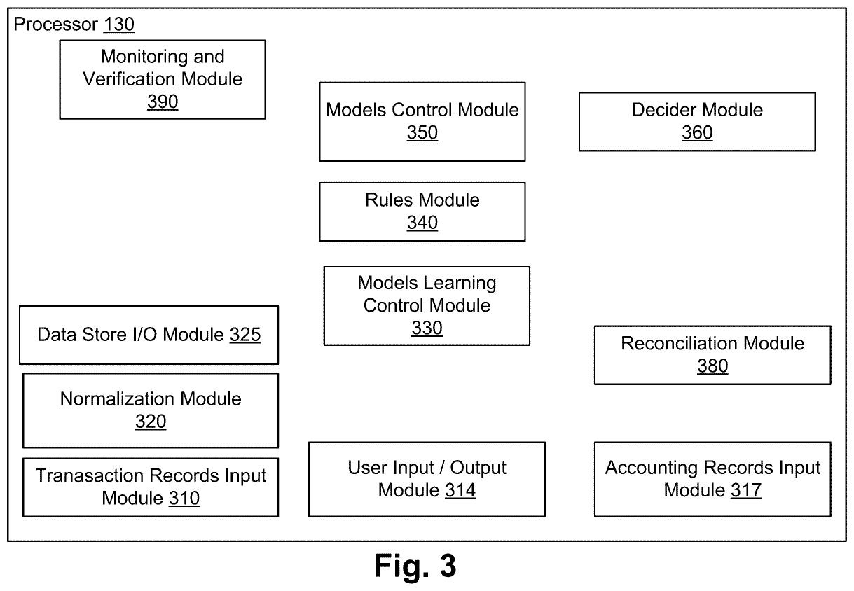

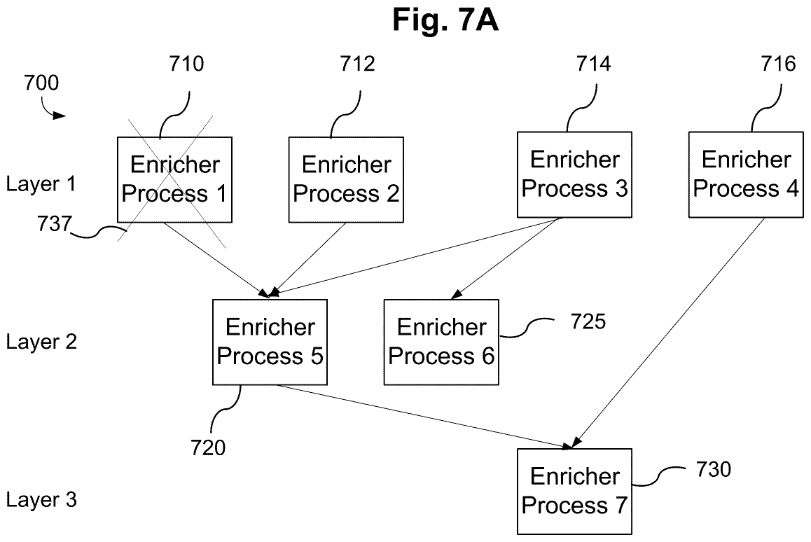

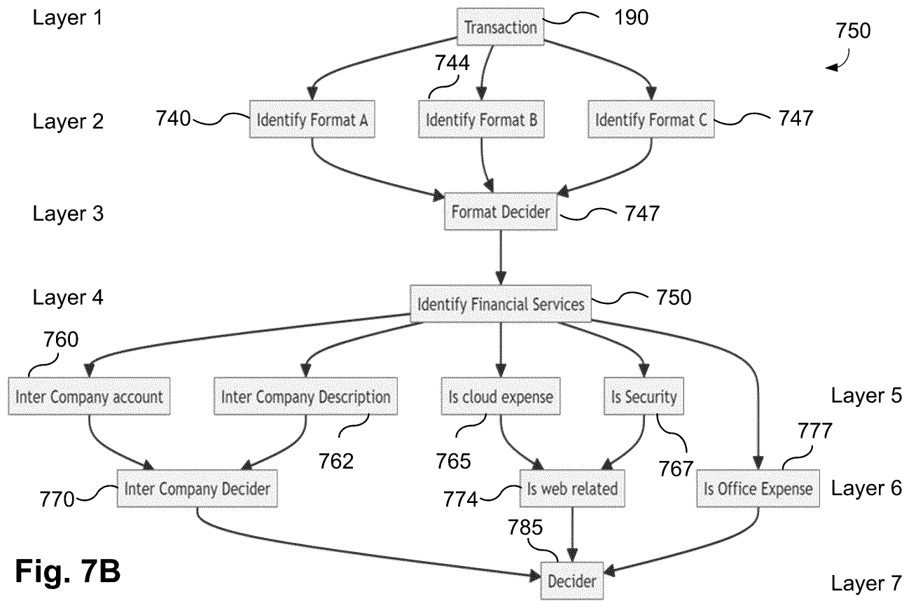

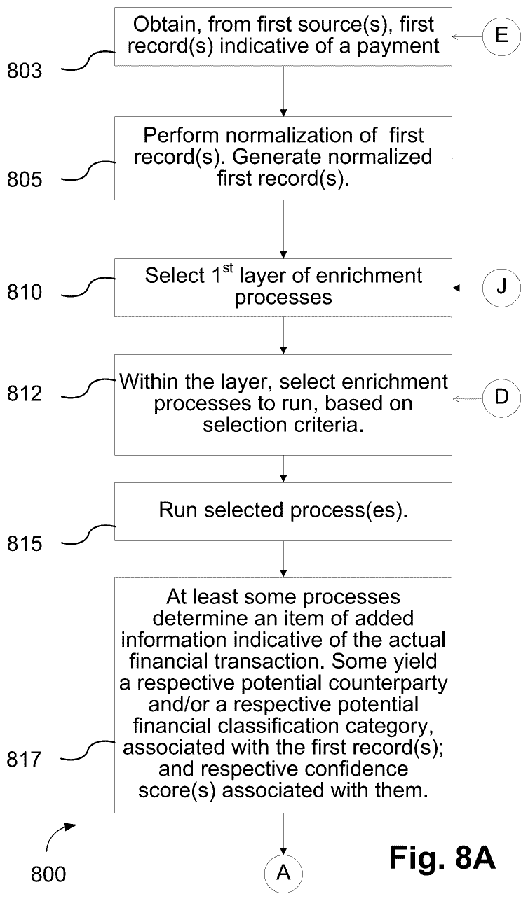

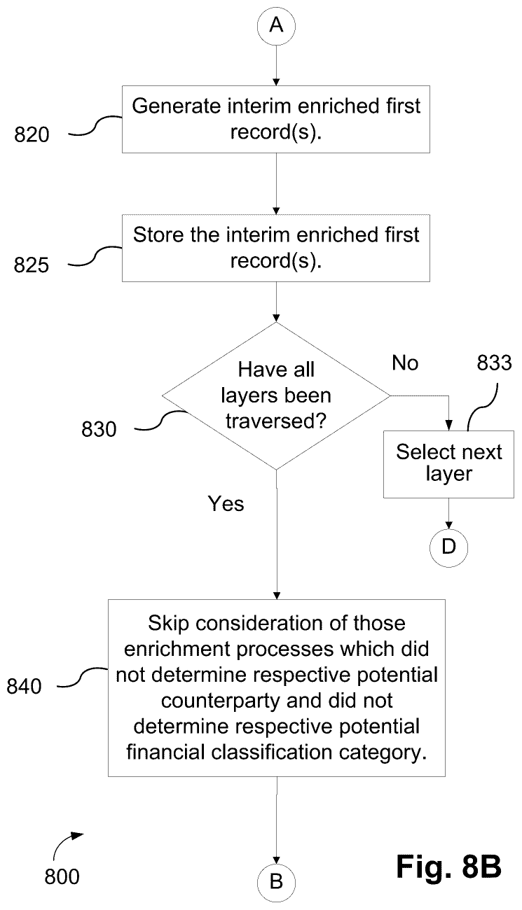

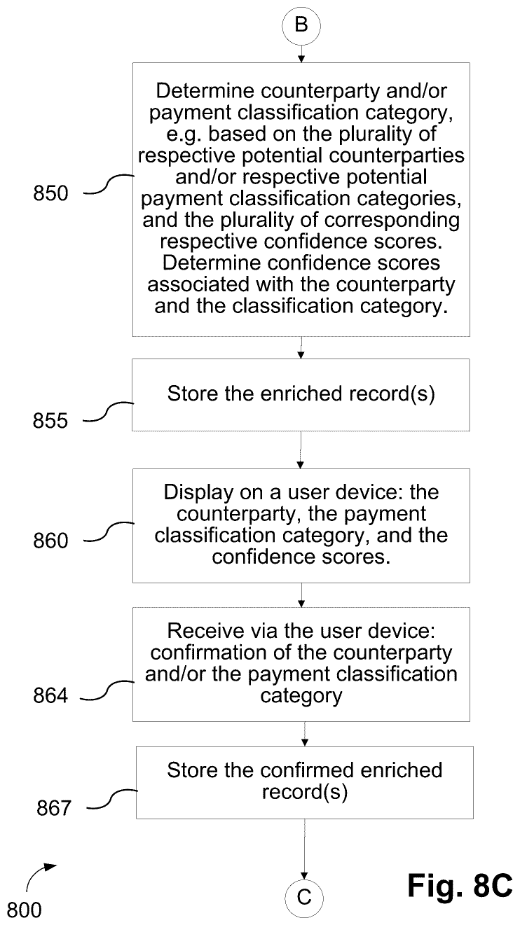

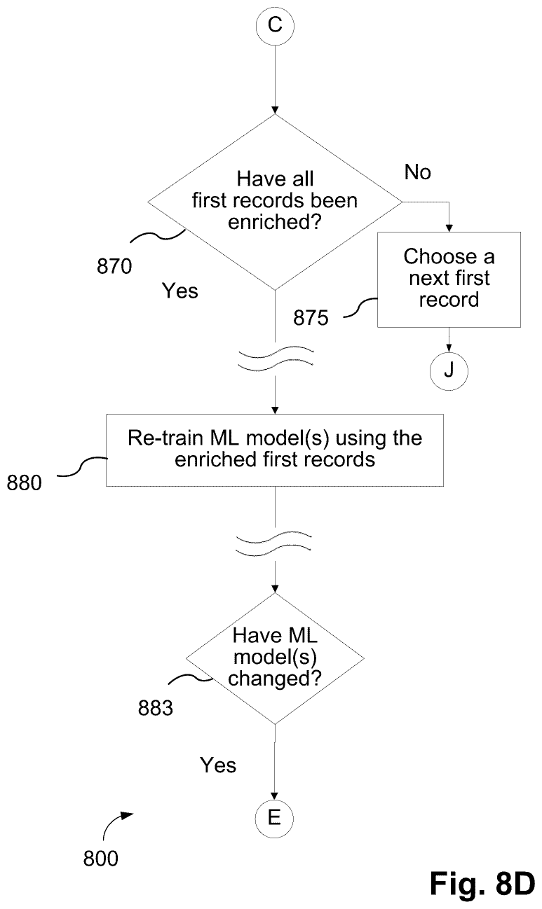

Various figures illustrate the concepts of the methods disclosed herein. FIG. 2 provides a conceptual diagram of layers of functionality. FIGS. 3-5 provide schematic diagrams of the processor, memory and data store disclosed with reference to FIG. 1. FIGS. 6-7 disclose illustrative schematic diagrams of the function of multiple enrichment processes. FIG. 8 discloses an example flow chart for a method of record enrichment and providing data pertaining to a record. FIG. 9 disclose an example flow chart of a method of reconciliation of records.

Additional advantages of the presently disclosed subject matter are disclosed further herein, with reference to one or more of the above-mentioned figures.

Attention is now drawn to FIG. 2, schematically illustrating an example conceptual diagram 200 of layers of functionality, in accordance with some embodiments of the presently disclosed subject matter. In some implementations, the system 110 can be seen, conceptually, as an architecture 200 operating as three functional layers. At the lowest layer, data connectivity layer 260, the system provides connectivity, via external interface(s) 155, e.g. to external systems 160, 162, 170, 180A, which provide records or other data, and to human users 185. This connectivity to multiple types of systems, and to systems which provide data e.g. of both actual financial transactions 190 and of accounting information 195, can facilitate enrichment of data 190, and thus of applications which rely on such enrichment, in a way that systems without such connectivity cannot.

At the next highest layer, the data enrichment layer 230, the first records 190, or other data 190, indicative of actual financial transactions, are enriched, e.g. as disclosed further herein with reference to FIGS. 1, 6-8.

At the top layer of the figure, the application layer 260, various applications can be performed to support technical improvement of business processes. In some examples, these applications utilize the enriched records generated/derived, and provided, by the enrichment layer 230. One example of such an application is reconciliation, disclosed further herein with reference to FIG. 9.

Again, the architecture shown here is only conceptual, and is only an example. In other implementations, there can be more or fewer functional layers. Similarly, in different implementations a particular functionality can be performed at different layers.

Similarly, it can be that a certain function “crosses” layer boundaries, in that it is performed e.g. in two different layers. For example, certain applications may perform enrichment as part of their functionality. The classification of various financial categories, including the categorization of an actual financial transaction as “intercompany”, and the determination of the counterparty, disclosed herein as part of the enrichment method, can in some cases also be viewed as applications, which use the machine learning models to derive specific business-related information that could not be obtained otherwise. Similarly, normalization of data formats disclosed further herein with reference to FIGS. 8, can in some cases be seen as part of the connectivity layer functionality; however, in some implementations it will make use of enrichment functions and processes/models.

Also, each of the functional modules exemplified in FIG. 3 is not necessarily performed at only one logical/conceptual/functional layer. In some cases, they can function at more than one layer.

Attention is now drawn to FIG. 3, schematically illustrating an example generalized schematic diagram of modules of a processor 130, in accordance with some embodiments of the presently disclosed subject matter. The processor(s) 130, of processing circuitry 120, can run various functional modules. In some examples, the functional modules are software modules stored on data store 150, and when executed they are loaded to memory 140 and run by the processor(s) 130.

In some examples, processor 130 comprises transaction records input module 310. In some examples, module 310 is configured to receive input records/data 190 of actual financial transactions from first sources such as bank(s) 160, payment service provider(s) 162, etc. These external systems can communicate, in some implementations, via I/O interface(s) 155 comprised in system 110—which can be e.g. various possible types of physical interface known in the art. The communication can be done e.g. over communications network(s) (not shown in the figures, for case of exposition).

In some examples, processor 130 comprises accounting records input module 317. In some examples, module 317 is configured to receive input records/data of accounting-related information 195 from second sources such as general ledger 180A, and ERP system 170, etc. These external systems can communicate, in some implementations, via I/O interface(s) 155 comprised in system 110. The communication can be done e.g. over communications network(s).

In some examples, processor 130 comprises user input/output module 314. In some examples, module 314 is configured to receive input information, such as labeling, from second sources such as a human user using User Interface system 185, etc. The module can also be utilized for a human user to confirm enrichment information, and/or reconciliation activity, as disclosed further herein with reference to FIGS. 8 and 9. In other implementations, there are separate user input and output modules (not shown). These external system(s) can communicate, in some implementations, via I/O interface(s) 155 comprised in system 110. The communication can be done e.g. over communications network(s).

In some examples, processor 130 comprises data normalization module 320. In some examples, module 320 is configured to normalize data formats of input transaction records 190, e.g. date formats of payments. In some examples, this is done instead using enricher models 410, 460 disclosed with reference to FIG. 4. In some examples, the normalization module 320 works in combination with the enricher models. In some implementations, this module receives first records from input module 310, and/or from storage 150 and/or memory 140. Example actions of such a module are disclosed with reference to FIG. 8.

In some examples, processor 130 comprises data store I/O module 325. In some examples, module 325 is configured to interface between the data store 150 and the modules of the processor and/or the enricher models 410, 460—e.g. to read and/or write first 190 and/or second records 195. This module is optional, since in other implementations the modules etc. can interface directly with the data store 150.

In some examples, processor 130 comprises models learning control module 330. In some examples, module 330 is configured to control the model training process, which is performed on the enricher models 410, 460 and is based on the first records and the second data. This includes also re-training of models based on new data, changed data, changes in models etc.

In some examples, processor 130 comprises models control module 350. In some examples, module 350 is configured to control the process of enriching first records 190 based on trained enricher models 410, 460. For example, the module decides which enrichers are run, and in what order. As disclosed further herein, the enriching itself can lead to additional model training, and thus modules 330 and 350 can function together. In some other implementations, these two modules can instead be one combined module.

More on training and use of the models is disclosed further herein with reference to FIGS. 6-8, and the methods of FIGS. 8-9.

In some examples, processor 130 comprises rules module 340. In some examples, module 340 is configured to perform a portion of the enriching method, using configured rules instead of machine learning models. This module is optional, since in some other implementations the enriching uses only models, without pre-configured rules.

In some examples, processor 130 comprises decider module 360. In some examples, module 360 is configured to decide the correct classification categories, counterparties, and other items of enrichment, based on the outputs of the various trained models 410, 460. More on this function is disclosed further herein with reference to FIGS. 6-8, and the methods of FIG. 8.

In some examples, processor 130 comprises reconciliation module 380. In some examples, module 380 is configured to perform the reconciliation process disclosed with reference to FIGS. 9, and/or to control the performance of that process. Note that other modules, as well as enrichment modules 410, 460, are in some implementations used as part of the reconciliation process, instead of, or in addition to, reconciliation module 380.

In some examples, processor 130 comprises monitoring and verification module 390. In some examples, module 390 is configured to monitor behavior of the other modules and of the models, so to e.g. ensure that no flaws happen, that and no errors occur, and that there is no undesired drift in results.

Attention is now drawn to FIG. 4, schematically illustrating an example generalized schematic diagram of a memory 140, in accordance with some embodiments of the presently disclosed subject matter. In some examples, memory 140 comprises machine learning enricher models 1 to M 410, 460. This is only a non-limiting example of data stored in the memory. In some examples, memory 140 can store some or all enrichment results, whether they are obtained by a machine learning enricher or by a rules-based enricher. It can also save the normalized form of the transaction, disclosed e.g. with reference to FIG. 8.

Attention is now drawn to FIG. 5, schematically illustrating an example generalized schematic diagram of a data store 150, in accordance with some embodiments of the presently disclosed subject matter. In some examples, data store 150 comprises first records 190, 510, received from first data sources 160, 162 etc., in a case where these raw first records 190 of financial transactions are stored on system 110. The records are in some cases received via transaction records input module 310. In other cases, the first records are processed before storing, and are not stored as is.

In some examples, data store 150 comprises enriched first records 530. These are enriched versions of first records 190, which have been enriched per the methods disclosed herein. In other examples, the enriched records 530 overwrite or otherwise replace the original first records 510. In some examples, these enriched first records include also interim enriched records 530, disclosed further herein.

In some examples, some of these enriched records 530 include information added by a human user 185, as part of a labeling process. This labeling information is an example of second data provided by a second source 190, distinct from the first source. This labeling can facilitate training of models 410, 460, to enable enriching of other first records.

In some examples, data store 150 comprises normalized first records 520. These are versions of first records 190, the format of which has been normalized—e.g. a normalized time and date format. In some examples, the normalization process utilizes enrichment, and the normalized records are within enriched first records 530. In such implementations, there may not be a need for a separate storage of normalized first records 520. Examples of normalization are disclosed with reference to FIG. 8.

In some examples, data store 150 comprises second records 195, 550. These are, for example, indicative of accounting information 195 associated with the business entity. The records are in some cases received from ERP 170 or ledger 180A systems, e.g. via accounting records input module 317.

In some examples, data store 150 comprises models structure data 560. Such information in some implementations describe the relation between various enricher models, such as the structure of layers of models, and dependencies between models—e.g. as disclosed further herein with reference to FIGS. 7A, 7B. In other cases, this data is stored in memory 140. More generally, this data is referred to herein as enricher structure data 560, applying also in cases where not all of the enricher processes 610 are models.

Attention is now drawn to FIG. 6, schematically illustrating an example generalized schematic diagram 600 of enricher interactions, in accordance with some embodiments of the presently disclosed subject matter. The diagram shows example interactions between multiple enricher processes and a database. A number M of enricher processes 610, 620, 630, 640 read from actual financial transactions database 650. For example, one or more processes (e.g. Layer 1 processes, per FIG. 7), read raw first records 510 (and, in some cases, normalized first records 520, not shown in the figure), perform enrichment actions (e.g. running the record through the model), and write additional information/enrichment information to the DB as enriched first records. In some cases, an enriched record is written by a first enricher(s) 610, and it is later modified by one or more second enricher processes 620, 630 (for example), one or more times—each time adding additional information, or modifying the information already written, providing additional information with respect to what was known from the original first record, thus adding additional context to that record. Thus, in this case the second enrichers read, as their input, enriched first records 530, rather than raw first records 510. In such a sense, such an enriched record (not shown) within records 530 is in some cases considered an “interim” record, until all enrichers have finished modifying/updating it and the decider 360 has made “final” decisions about the enrichment (confirming or overruling).

In other cases, the record is considered an “updated record” 530, in the sense that it can continue to be further enriched even at a later date, even after the decider has made its decision. The further enrichment could occur e.g. after enricher processes/models are modified and/or added, running existing enrichers after possible changes in the data, and/or running existing enrichers after changes in system configuration. (An example of a change of data is additional information received from the ERP 170. An example of a configuration change, is the change in a rule stating at what confidence level a decider should ignore information from an enricher(s).) In some cases, there are no “final” enriched records, as they can always be further enriched. For simplicity of exposition, the term “interim enriched records” is used throughout the document, but it should be understood in all places to refer to “updated enriched records” as well, where relevant.

Context here refers generally to information relevant to the particular actual financial transaction 190—whether the information specific to the transaction itself, to the business entity, to the other party/counterparty, etc.

Thus, at least some enrichment processes are configured to derive at least interim (and/or updated) enriched first records. They can possibly also deriver or generate “final form” enriched records, on which no further enrichment is performed before the resulting record is provided. Note that an interim record in 530 is in some cases accessed by second process/model 620, after having been created by enricher 610. Thus, the enrichers in some cases read also enriched records 530, e.g. interim enriched records 530.

That is, an enricher 620 stores the enriched record, e.g. in data store 150, e.g. writes to the transaction database 650, and other enrichers 610, 630 take the enriched records and process them further. As the various enrichers are run, the record is further and further enriched, with more and more context added, sometimes in an iterative process. Note that in some example cases, after enricher 620 writes additional context to the record, and one or more other enrichers 610, 630 add their additional context, enricher 620 may be able to read the further-enriched record, process it again, and add even more context/information to the enriched record.

Thus, in some examples the performing of the enrichment method comprises:
I. performing a plurality of enrichment processes 610, 620, 630,
   where each enrichment process 620 determines an item of added information (not shown), which is indicative of the actual financial transaction 190 represented by the first record in 530.

Also, in those examples where an output of the overall enrichment method is the determination of at least one of the counterparty and the financial classification category (along with possibly other parameters/information), another process 610 is configured to utilize the interim enriched first record, generated by a process 620, in the determination of the counterparty and/or the financial classification category.

For ease of exposition, the figure depicts an actual financial transactions database 650, which comprises first records 510 and enriched first records 530. This is one non-limiting example implementation. In some examples, this database 650 is comprised (although not shown separately) in data store 150, which comprises records 510 and 530.

At least some of these enricher processes are, or utilize, enricher models 410, 460, as disclosed with reference to FIG. 4. That is, one or more of the enrichment processes are associated with one or more machine learning (ML) model 410, 460. In at least this sense, the enrichment method of FIG. 8 utilizes at least one machine learning model trained to identify correspondence, of the first records indicative of actual financial transactions associated with a business entity, to the second data.

However, in certain example implementations, one or more of the enrichment processes performs the determination at least partly based on configurable rules. Such rules are used by this process, in some cases, instead of using an ML model. Such an enricher uses, for example, rules module 340. An example of a configurable rules engine is one that performs a rule such as “If the text in the payment (or other actual financial) transaction includes the string XXX, decide that the financial category is YYY”. Similarly, in some other examples, a particular enriching process 610 has mixed function, where it utilizes a model 410 for certain functions, while other parts of functions of that enricher are rules-based.

In some examples, at least some enrichment processes 610, 620 determine a respective potential counterparty and/or a respective potential financial classification category, associated with the first record 190. This determination thereby generates a plurality of respective potential counterparties, a plurality of respective potential financial classification categories. In some examples, the performing of the enrichment further comprises determining at least the counterparty, and/or at least the financial classification category, based at least on these potential counterparties and/or potential financial classification categories. The determination of the counterparty, and/or the financial classification category is performed in some implementations by decider 360, e.g. as disclosed further herein.

That is, one or more of the enrichers 610 determine potential financial categories or potential counterparties. One example is an enricher model that determines if an invoice number appears in a bank transaction record 190. If this is true, the transaction is likely of the financial category “income”, or perhaps a “refund” from a supplier due to overpayment.

Note that, in some implementations, some of the other enrichers 620 perform a different job, providing a different output, rather than determining potential financial categories or potential counterparties. In one example of such another enricher, an enricher model runs early in the overall process (e.g. per FIGS. 7 and 8), and determines the data format, so as to parse the fields. Another example is an enricher that identifies names of financial institutions—e.g. “Bank AAA”. A different enricher, or the same one, then analyzes the transaction 190, to see exactly what type of payment it is, and thus categorize it. Still another example enricher finds the account number (and/or account name, in some example) of the counterparty. A different enricher then looks for that account number in the list of “affiliated entities” of the particular business entity, and if such is found, the record 190 is determined to be of category “intercompany”. Still another example enricher reviews the history of transactions 190 with the bank account number seen in the first record 190, determines that company F has paid from that account number in the past, and thus determines that the current first record 190 involves company F.

As exemplified above, typically, other enrichers use the output of enrichers such as the above, to further enrich the records 190, so as to eventually determine at least the potential financial categories or potential counterparties.

Additional examples of enrichers are disclosed further herein.

In some examples, the system 110 decides between results derived from the multiple enrichers 610, 620, e.g. using decider module 360. For example, the decider 360 decides, among other parameters, what are the most likely financial categories and/or counterparty of a particular transaction, and in some cases determines the confidence score for each of them. The decider function can also decide on the values of other parameters.

Consider an example where enricher 610 determined that the counterparty is “company P” and enricher 620 determined that the counterparty is “company Q”, while a third enricher determines that it is “company PP”. (Note that all enrichers provide also a confidence score, in some implementations). In some examples, the decider decides using a voting technique, e.g. using known per se techniques. One non-limiting method for performing the voting is to use a machine learning model (not shown in the figures).

In one example implementation, at least some enrichment processes 610 further determine at least one respective confidence score associated with a determination (e.g. of potential financial categories and/or counterparty). These enrichment processes thereby generate or derive a plurality of corresponding respective confidence scores, e.g. one associated with each determination. In such examples, the determination of the counterparty, the financial classification category, and/or other parameters, e.g. by the decider 360, is based at least on these corresponding respective confidence scores. In some such implementations, the performing of the enrichment further comprises determining (e.g. by the decider 360, e.g. using the voting method), one or more confidence scores associated with the final determined counterparty and with the payment classification category.

Consider an example where four 610, 620, 630, and 640 of the enrichers are all configured to determine potential financial classification categories and also a potential counterparty. The decider is thus configured to determine the financial categories and counterparty based on all four. However, in the example, enricher 610 was unable to determine either any potential financial categories and or a potential counterparty—it failed to provide a result. In effect, its result is “no answer, I don't know, I have nothing to add to the analysis”. Enricher 620 provided a potential counterparty, but no potential financial categories, i.e. it was “partially successful”. Enrichers 630 and 640 were each able to output both parameters, that is to enrich the record 530 with context on both. Decider 360, when deciding the counterparty and financial classification category, and when deciding the confidence scores of each (if relevant), skips consideration of those enrichment process which did not determine the respective potential counterparty and/or did not determine the respective potential financial classification category. In this example, only processes 630 and 640 are considered in the decision made regarding financial categories. Similarly, only processes 620, 630 and 640 are considered in the decision made regarding counterparty.

The above illustration applies also to other parameters for which a decision is made, as relevant.

A best practice is, in some implementations, to provide confidence scores for all decisions. For example, an enricher 610 is configured to identify the account number, and the account number is indeed found in the expected location within the record—the format seems to be correct. But if there is a space in the account number, there may be a question whether that simply a typo in the record, or whether the present of the space mean that the particular field is in fact NOT an acct number. Therefore, such a determination may also generate an associated confidence score, and the decider uses the confidence score of such a determination when deciding whether that field is in fact the account number. A low confidence in the account number can cast a doubt on all results and decisions that depend on that determination. In some cases, each enricher process 610 knows what determinations were made before it ran, and each associated score. Enricher 610 can use these various confidence values to help determine the confidence score of its own output determination. However, if multiple enrichers provide the same counterparty or financial category (or other parameter), all with a relatively low confidence score, this can, in fact, cause the decider 360 to assign a high score to this determination. The agreement of multiple enrichers (especially when they are unanimous) can trigger a higher confidence in the determination.

In one example, system 110 (e.g. decider 360) determines a separate confidence score for each parameter, that is for each piece or component of information in first transaction records 190, 510. This is one typical behavior. For example, the counterparty is one of the business entity's clients, but there are three clients with similar names. Therefore, it is hard to be certain which of the three clients the counterparty it. On the other hand, it is quite clear to decider 360, that the financial category of the same transaction is “income”. In such a case, for the same first record 190, the decider determines two different confidence scores: counterparty confidence=70%, but category confidence=95%.

However, in some examples, certain enrichers 620 always give the same confidence level, no matter that the input first record 190. Also, in some implementations the system 110 includes third part enrichers 630, provided by a third party. However, some third-party enrichers, while they know how to e.g. parse the data structure of transactions of a certain bank 160, the third party does not share the score with system 110. Therefore, the confidence score is often desired, and is often a best practice, but it is not mandatory.

One current best practice implementation for a decider 360 is a supervised machine learning model, which learns how the corresponding confidence score, associated with each determination of each enricher 410, 610, is likely to indicate that the final determination by the decider is similar to the determination made by that enricher.

Note that enrichment of a record for Company A can in some cases be performed based on learning done based on records of Company B. Even if the system is configured to not share data of one business entity with another, there can be e.g. a case where for some records P and Q, which are associated with Company B, it has been learned that the counterparty is Company C, and that the records P and Q are categorized as office expenses. The system characterizes Company C, and the system can use this characterization across business entities, not only for Company B's records. That is, such learning can be used also when a new record R is received, for Company A. When Company C will be a counterparty of Company A's transactions, the system will identify the similarity of record R to records P and Q, and can use this knowledge to help format and classify the new record R.

The diagram of FIG. 6 is only one simplified illustrative example. In common implementations, the system 110 uses dozens, or even hundreds, of enrichers 610, 620, 410, 460.

A number of non-limiting examples of enrichment processes 610 are disclosed above. Other example enrichers 610 perform at least identification of one of the following:
(i) the format of the one or more portions of the first record 190, 510;
(ii) financial services associated with the first record;
(iii) financial/business entities associated with the first record (including one or more counterparties);
(iv) whether the actual financial transaction is an intercompany transaction;
(v) transaction type;
(vi) time zones of transaction-related time stamps, in case where time zone-related information was not provided;
(vii) whether a transaction is pending or final, and in some cases linking between a pending and a final transaction;
(viii) deposits;
(ix) withdrawals;
(x) bank fees;
(xi) income through a financial vendor
(xii) payroll transaction;
(xiii) office expenses;
(xiv) cloud services expenses;
(xv) security services expenses;
(xvi) web-related expenses;
(xvii) tax payments;
(xviii) social security payments; and
(xix) software license fees.

In some examples, having generated enriched first records 530, the system 110 is further configured to perform re-training of the machine learning model(s) 410 using the enriched first record, thereby obtaining updated machine learning model(s) 410. That is, the currently enriched records can be used to improve the models. Note that use of enriched records 530 to re-train models is one possible purpose of storing enriched records.

In addition, in some cases a new enrichment process 630, 460 is added to the system 110. For example, a new model is developed, or is acquired from a third-party supplier—or alternately, an updated version of an existing model is made available to system 110. In some such cases, the method of the presently disclosed subject matter further comprises: responsive to adding the new enrichment process to the system, performing again also one or more of the existing enrichment processes 610, 620 in respect of the enriched first record(s). It can be that the new process further enriched the records 530, such that also the existing enrichers can derive additional context or other information from the existing enriched records (which have now become further enriched). Synergistically, the enriched records become more and more enriched.

Attention is now drawn to FIG. 7A, schematically illustrating an example generalized schematic diagram 700 of enricher hierarchy, in accordance with some embodiments of the presently disclosed subject matter. The diagram shows example structural relationships 700, and priorities, among multiple enricher processes 610, 620. As disclosed with reference to FIG. 6, in some implementations, multiple enrichers, at least some of them machine learning models 410, are run, each possibly further enriching a first transaction record 530, 190. In some implementations, it is technically advantageous to run the enrichers on a particular first record in a particular order, e.g. based on an hierarchal structure and with certain priorities. Note that FIG. 7B provides a particular illustrative example of such an architecture.

Thus, in some cases the performing of the enrichment method (e.g. per FIG. 8) further comprises selecting enrichment processes to perform, based on selection criteria. In some examples, these the selection criteria are selected from a group comprising:
(i) the relevance of a selected enrichment process to the particular first record(s) (referred to herein also as a first relevance);
(ii) the relevance of the selected enrichment process to the business entity (referred to herein also as a second relevance, to distinguish it from the above “first relevance”);
(iii) the relative priority of the selected enrichment process;
(iv) dependence of the selected enrichment process on one or more other enrichment processes; and
(v) configurable rules.

In the non-limiting enricher architecture of the figure, there are seven enricher processes, at least some of which utilize machine learning models 410. The enrichers are arranged (logically) in several layers, in a priority- or precedence-based layered structure. Due to the particular nature and function of the enrichers of this figure, enricher process 5 720 should not be performed before processes 1, 2 and 3, 710, 712, 714. That is, the selected enrichment process 720 depends on one or more other enrichment processes 710, 712, 714. Note that process 710 is crossed out. This is explained further herein.

Enricher process 6 725, also, should not be run before process 3 714. That is, the relative priority is that 725 should be selected after 714. Process 725 in some examples depends on the completion of the running of 714, that is on the enrichment process performed by 714 on the first record 190, 530. The architecture therefore positions 720 and 725 at layer 2. Enricher process 7 730 should be run after both processes 5 and 4, 710, 716. Process 730 is thus located at layer 3. This particular set of dependencies/precedence gives rise to the particular layered architecture/topology shown.

The definition of layers is a topological definition. Those processes which have no dependency are defined as layer 1 (in the example of the figure). Those which depend on enrichers in layer 1 only are defined as layer 2. Those which depend on enrichers in layers 1 or 2 only are defined as layer 3, and so on.

The four processes of layer 1 could be run in parallel, as they do not depend on others. They are thus all placed at layer 1. Of course, it can be that e.g. process 712 takes twice as long to run as process 714, for all first records or for specific first records. Both processes 720 and 725 have to wait for completion of 714, so they are on the same layer. Note that two processes at the same layer may start processing a particular record 510, 530 at different times. For example, if, for a particular record, processes 714 and 710 take 10 milliseconds (ms) each, but 712 takes 20 milliseconds, 720 will have to wait for 712 to complete, and can start only after 20 ms, while 725 can start already after only 10 ms.

In a case such as that of the figure, performing the enrichment thus further comprises: performing the plurality of enrichment processes in a particular order, based on dependencies among the plurality of processes.

In this non-limiting example, the structure is fixed for all first records 190, purely for simplicity of illustration. In other cases, the dependencies architecture can be based on the particular first records. For example, transaction records coming from Bank AAA 160 follow the precedence architecture 700 of the figure, while those from Bank BBB 160 follow a different architecture (not shown, for simplicity), due to the peculiarities of the types and formats of data that appear in each bank's records.

Note that enricher process 1 710 is shown as crossed out 737. Recall that selecting a particular enricher to run can be based on the relevance of the selected enrichment process 710 to the business entity, to the first source 160, 162, or even to the particular first record(s) 190. For example, a particular enricher is not relevant for US banks 160. For any transaction record 190 coming from a US bank, process 710 is skipped, and the dependent process 720 need not wait for it to complete before it can run. In at least this sense, process 710 is filtered out, and system 110 can be considered to include a filter (e.g. models control module 350) which determines which enrichers will be applied a to a particular financial transaction first record 190. The filter in effect modifies the architecture 700 for the record. Thus, the dependence architecture 700 is not necessarily fixed.

Another example of selection criteria for enrichment processes 610 is configurable rules. For example, the system 110 can have configured, for the business entity Company A, which enrichers are run or skipped, and in what order and with which dependencies they are run.

Attention is now drawn to FIG. 7B, schematically illustrating an example generalized schematic diagram 750 of enricher hierarchy, in accordance with some embodiments of the presently disclosed subject matter. The diagram gives a particular, highly simplified, illustrative example of the structural relationships 700, and priorities, among multiple enricher processes 610, 620, which were disclosed in a more general way in FIG. 7A.

The incoming first record 190 (which can be stored as 510) is analyzed, e.g. in parallel, by each of three different “format identification” enrichers 740, 744, 747, e.g. ML models 410. In the example, each analyzes the record to see if it matches particular format (formats A, B and C respectively). For example, each enricher gives a score for its associated format. Recall that some enrichers can be models 410, while others can be based on e.g. configurable rules.

The format decider 747 chooses from the three formats, deciding which format fits the record best—e.g. based on the scores it received from each of the three enrichers. Notice that in some examples, decider 747 is part of decider module 360, or is an instance of module 360 (which might have several instances, each deciding different parameters). Also, in some examples, the decider can itself be a machine learning model 410. These options apply as well to other deciders in the figure, for example. Also, a decider such as 747 can be conceptually seen as an enrichment process, where the enrichment is the making of a decision, e.g. with a confidence score, and storing that information in the enriched record 530 for use by other processes.

Note also that format decider 747 is a non-limiting example of a decider 360 which does NOT necessarily determine parameters such as counterparty and classification category, but rather decides on other parameters—in this case format Note that this determination is made for the use of other enrichment processes. Note also that the dependencies and priorities in the architecture are evident-until the record format has been decided, the parsing is not complete, and it is not clear what the values of the various fields (account number, date, amount, currency etc.). Other enrichers cannot begin their analysis until such information has been determined, and thus are dependent on the completion of the work of Layers 1 to 3 in FIG. 7B.

Continuing down in the topology, Layers 4 to 7 all function to identify financial classification categories. At Layer 4, process 750, “Identify Financial service entities”, finds all financial service entities/business entities in the transaction represented by (enriched) record 190, 530.

The enrichers of Layer 5 consider example individual financial services. Enrichment processes 760 and 762 both consider the possibility of an intercompany transaction: 760 analyzes if the transaction is inter-company type by looking at the description, while 762 analyzes if the transaction is inter-company type by looking at the account number. Jumping briefly to Layer 6, the intercompany decider 770 depends on these two, and determines, based on their outputs, whether the “intercompany transaction” financial classification category should be applied.

Reverting to Layer 5, enricher 765 determines whether the actual financial transaction is associated with a cloud services expense, while enricher 767 determines whether the actual financial transaction is associated with a security service expense. At Layer 6, decider process 774 determines whether the transaction is a web related expense (whether it is cloud- and/or security-related).

In some examples, enricher process 777 analyzes the enriched record to determine if the transaction type “office expense” is relevant and applicable. Note that, although shown in Layer 6, process 777 can instead be considered as on Layer 5. That is, in terms of controlling the actual performance of e.g. running of models (e.g. controlled by models control module 350), the system has the flexibility to start as early as the start of other Layer 5 models/enrichers, or to finish running as late as the end of completion of the Layer 6 deciders/models.

At Layer 7, the final one of the example figure, a decider 785 makes a “final” determination of transaction type. All appropriate financial categories are determined (there can be multiple categories for a transaction, e.g. “an intercompany office expense”). Counterparty and other parameters can be decided on (although the architecture for that part of the work is now shown, for simplicity of exposition). The enrichment process for this record is completed. Note that in some cases the enrichment and assignment of parameters may in fact continue at a later point in time, e.g. do modification of enricher models—e.g. as disclosed with reference to FIG. 8.

Again, some or all of the enrichers and deciders can determine confidence scores for the various parameters, thereby assisting in decisions at the next stage/layer.

In some examples, structure data regarding the architecture 700, 750 of enricher models or other enricher processes 610, is stored in models structure data/enricher structure data 560, e.g. stored in data store 150.

FIGS. 1-7 illustrates only general schematics of the system architecture, describing, by way of non-limiting example, certain aspects of the presently disclosed subject matter in an informative manner, merely for clarity of explanation. It will be understood that the teachings of the presently disclosed subject matter are not bound by what is described with reference to FIGS. 1-7.

Only certain components are shown, as needed, to exemplify the presently disclosed subject matter. Other components and sub-components, not shown, may exist. Systems such as those described with respect to the non-limiting examples of FIGS. 1-7 may be capable of performing all, some, or part of the methods disclosed herein.

Each system component and module in FIGS. 1-7 can be made up of any combination of software, hardware and/or firmware, as relevant, executed on a suitable device or devices, which perform the functions as defined and explained herein. The hardware can be digital and/or analog. Equivalent and/or modified functionality, as described with respect to each system component and module, can be consolidated or divided in another manner. Thus, in some embodiments of the presently disclosed subject matter, the system may include fewer, more, modified and/or different components, modules and functions than those shown in FIGS. 1-7. To provide one non-limiting example of this, in some examples, normalization module 320 and models control module 350 are combined into one module. Similarly, in some user I/O module 314 can instead be two modules-one for user input and one for user output.

One or more of these components and modules can be centralized in one location, or dispersed and distributed over more than one location, as is relevant. In some examples, certain components utilize a cloud implementation, e.g. implemented in a private or public cloud.

Each component in FIGS. 1-7 may represent a plurality of the particular component, possibly in a distributed architecture, which are adapted to independently and/or cooperatively operate to process various data and electrical inputs, and for enabling operations related to computerized object detection. In some cases, multiple instances of a component may be utilized for reasons of performance, redundancy and/or availability. Similarly, in some cases, multiple instances of a component may be utilized for reasons of functionality or application. For example, different portions of the particular functionality may be placed in different instances of the component.

Communication between the various components of the systems of 1-7, in cases where they are not located entirely in one location or in one physical component, can be realized by any signaling system or communication components, modules, protocols, software languages and drive signals, and can be wired and/or wireless, as appropriate. The same applies to input and/or outputs such as modules 310, 314, 317, and to the external interface(es) 155 of system 110.

Attention is now drawn to FIGS. 8A-8D, schematically illustrating an example generalized representation 800 of a process flow 800, in accordance with some embodiments of the presently disclosed subject matter.

This process 800 is configured to provide data pertaining to a record 190, e.g. by enriching the record. The process is, in some examples, carried out by systems such as those disclosed with reference to FIGS. 1-7. The flow 800 starts at 803 of FIG. 8A.

According to some examples, a first record 190, indicative of an actual financial transaction, paid or otherwise transacted via first source(s) 160, 162, is obtained from the first source(s) (block 803). In some examples, this is performed by transaction records input module 310, e.g. interfacing via one or more external interfaces 155 and communication network(s) (not shown in FIG. 1).

According to some examples, a normalization of the first record is performed (block 805). The block thereby generates a normalized first record 520. After enrichment, the method will thereby generate a normalized enriched first record 530. In some examples, this normalization action comprises:
(1) assigning a fixed number of fields to the normalized first record;
(2) populating one or more fields of the normalized first record;
(3) normalizing a format of at least one of the fields; and
(4) adding a field with a value of the transaction in a normalized currency. For example, the field shows the US dollar value of the transaction, regardless of the actual currency of the transaction. In other examples, a different reference currency (e.g. Euro) can be defined, whether globally in the system, per business entity etc.

Consider, for example, a case where a bank 160 sends first records 190 with anywhere from 2 to 15 fields. The block normalizes the 2 to 15 fields to e.g. 5-6 fields, and assigns a standard format to at least some of the fields, e.g. a standard format of date.

Note that certain first sources 160 can have some fields in common, and some fields which differ from source to source. In some implementations, the standard chosen by the system is a “merging” of the formats of each bank, e.g. a super-set of the standard fields of each bank. The system can populate the fields which the bank provide using the enrichment.

In some examples, this block is performed by normalization module 320. In the example of the figure, this block is performed before the various enrichment processes are run. In some other implementations, normalization is part of the enrichment, so it can be part of later steps such as 810-833, rather than a separate step 805 at this point in the flow.

It should be noted that in Europe there is a standard for open banking, demanded by the regulator, that solves many of the normalization challenges for such records.

According to some examples, the first layer of enrichment processes is selected (block 810). In some examples, this is performed by models control module 350. In the examples of FIGS. 7A and 7B, Layer 1 is selected. Since the enrichers 710, 712, 740 of that particular layer are not dependent on the running of other enrichers, those are selected as the first to be run. This is an example of selecting enrichment processes based on selection criteria.

Note that the blocks of the flow associated with layers (e.g. 810, 812, 830, 833), and/or details of the blocks that relate to layers, are relevant only for implementations which make use of a layered architecture of e.g. FIG. 7. Such an implementation is used herein just for illustration of an exemplary process flow FIG. 8. In addition, also when using a layered architecture, it can be that different enrichment processes within a layer are run at different points in time on a particular record 190, 510, 530, based on the dependency architecture and on the speed at which a particular process completed the record handling. Some can run on a particular record in parallel. In some cases, a particular process 725 of a “later” layer (e.g. Layer 2), can start running on a record while a process 712 of e.g. Layer 1 is still running.

According to some examples, within the selected layer, one or more enrichment processes are selected to be performed, based on the relevant selection criteria (block 812). In some examples, this is performed by models control module 350. For example, the enrichers 710, 744, belonging to the selected layer, are selected. Enricher process 747 is not selected to be run, but rather is skipped, since it is not relevant to the particular record 190 that is being processed, or is not relevant to the business entity Company A associated with the record, etc. In some cases, the selection is based on configurable rules.

In some examples, the selected enrichment process(es) are performed, based on the relevant selection criteria (block 815). In some examples, this is performed by models control module 350, running the enrichment models 410, 460, 610, or other enrichment processes 610, 712, 740, and/or running rules module 340. In cases where one or more portions of the first record 190 are of a non-fixed format, the performing of these enrichment processes includes analyzing the portion(s) of the first record that have a non-fixed format. In some examples, the process is run on an enriched first record 530, e.g. where one or more of the processes has already enriched the record 190.

Recall that in some implementations, the machine learning model(s) have been trained to identify correspondence, of the first records 190 indicative of actual financial transactions associated with a business entity, to second data, obtained from second source(s) 185, 170, distinct from the first source(s) 160, 162. In some implementations, the second data are based on input of human user 185, e.g. labeling the first records 190. In others, the second data comprise second records 195 indicative of accounting information associated with the business entity. For simplicity of exposition, the training stage of models (often performed earlier and offline), is not shown in the flow, although retraining step 880 is shown.

Note that in some examples, multiple layers of models/processes 610 are running simultaneously. For example, first record A arrives at system 110, is processed by enrichment process 714, and is now sent to process 725 at layer 2. While process 725 is processing/analyzing record A, record B arrives at the system and is run through the process 714 at Layer 1, at the same time.

In some examples, at least some of these enrichment processes determine one or more items of added information indicative of the actual financial transaction associated with first record 190 (block 817). In some examples, this is performed by enrichment models 410, 460, 610, or other enrichment processes. In some cases, at least some enrichment processes determine one or more respective potential counterparties and/or one or more respective potential financial classification category, associated with the first record 190. In some such cases, the process(es) also determines one or more respective confidence scores associated with at least some of these determinations. Note that confidence scores are optional.

In some implementations, at least one of the enrichment processes 610 performs the determination at least partly based on configurable rules.

The flow continues A to block 820 on FIG. 8B.

In some examples, at least some of these enrichment processes derive interim enriched first record(s) 530, based on the respective first record(s) 190 (block 820). In some examples, this is performed by enrichment models 410, 460, 610, or other enrichment processes. These interim records include the items of added information, which were added at block 817.

In some examples, the enriched records 530 (including interim enriched first records 530, as relevant), are stored (block 825). In some examples, this is performed by enrichment models 410, 460, 610, or other enrichment processes 610, and/or by models control module 350, e.g. interfacing with data store I/O module 325, to store the records in data store 150, e.g. as enriched first records 530, e.g. in actual financial transactions database 650. In other implementations, at least some enriched records are not stored in a data store, and they are instead kept in memory 140.

Note that in some examples, another enricher process 620 is configured to utilize the interim enriched first record, generated and stored by the particular enricher process 610, in the determination of the counterparty and/or the financial classification categories.

In some examples, a determination is made, whether all of the layers of the enricher architecture 700, 750 have been traversed—that is whether all relevant enrichers 610 have been selected and run (block 830). In some examples, this is performed by models control module 350.

In some examples, responsive to a determination at block 830 that no, not all layers have been traversed, the flow proceeds to block 833. In some examples, the next layer, or in some cases the next relevant layer, of the enricher architecture 700, 750, is selected (block 833). In some examples, this is performed by models control module 350. The flow continues, D, looping back to e.g. block 812 on FIG. 8A.

Note that this implementation assumes that a particular record is processed by each enricher in turn, in a certain order such as that prescribed by e.g. the layer architecture of FIG. 7B. In other implementations, at least some enrichers 410, 610 can be invoked again after a change in the metadata, i.e. after further context has been added by an enricher 620 that ran after the first run of the enricher 610 (other enrichers output). This can happen one or additional times for the enricher. The configurations of the system 110, e.g. in models control module 350, are such that the flow in not endless, that is that enricher 610 will not run endlessly on the same enriched first records 530.

In some examples, responsive to a determination at block 830 that yes, all layers have been traversed, the flow proceeds to block 840. In some examples, a determination is made to skip, from consideration in the decision process, those enrichment processes which did not determine the respective potential counterparty and/or did not determine the one or more respective potential financial classification categories (block 840). That is, the next block 850 will decide on these parameters, and will consider only those enrichers which are configured to output those parameters, and which in fact succeeded in finding values of them.

This step is also relevant for other parameters, if the block 850 decision will be for values of those other parameters (in addition to, or instead of potential counterparty and/or financial classification categories). In some examples, this step is performed by models control module 350 and/or by decider modules 360.

The flow continues B to block 850 on FIG. 8C.

In some examples, a determination is made about various parameter(s) of a particular first record 190 (block 850). In some examples, this is performed by models control module 360. For example, the module determines the counterparty associated with the first record, and/or one or more financial classification categories associated with the record. In some examples, these determinations are based at least on the plurality of respective potential counterparties and/or on the plurality of respective potential financial classification categories, which were determined by the enrichers 610 at block 817. In some examples, these determinations are based at least on the plurality of corresponding respective confidence scores determined at block 817. In some examples, the decider 360 also determines one or more confidence scores associated with the counterparty, with the payment classification categories and/or with the other parameters that it determines. The determined confidence may be at least partly based on the plurality of corresponding respective confidence scores determined at block 817.

In some examples, a voting method is utilized for these decisions.

Note that in the non-limiting example of flow 800, there is one decision step, performed in block 850. In other implementations, e.g. such as that of FIG. 7B, there are several decider processes, making a decision about relevant parameters, at different places within the enricher flow and architecture. In such an implementation, the flow 800 would be modified accordingly.

In some examples, the enriched record including the outputs of block 850 is stored (block 855). In some examples, this block is the same as, or similar to, block 825.

In some implementations, the enriching is a fully automated process, performed by the system 110, and arriving at decisions about parameters such as counterparty, without any human user intervention. However, in some other implementations, a human user 185 is included in the process, to provide confirmation and oversight of the results. Since this is only one possible implementation, a number of blocks 860, 864, 867 in the remainder of this flow 800 are relevant only in such a case. Although in the flowchart blocks such as 864 are shown in as part of a serial flow, this is done only for ease of exposition. In more typical implementations, the automated process (and that of FIG. 9 as well) is performed for a number of records 190, and the display and confirmation of e.g. 860, 864 are done in a bulk manner, asynchronously from the enriching of each record.

In some examples, at least the counterparty, the financial classification category, and/or other parameter values are relevant, are displayed on a user device 185 (block 860). Optionally, one or more of the generated confidence scores are also displayed, as relevant. In some examples, this is performed by user I/O module 314, e.g. via external interface(s) 155 and communication network(s) (not shown).

In some implementations, the displaying of the confidence score is in a qualitative fashion. For example, the system 110 tells user 185 that record 190 has counterparty Company H with one of e.g. high, medium, med-low, low confidence. This can be easier for the user to understand than numeric values such as e.g. “87.6% confidence”.

In some implementations, the displaying of the parameters is performed only when the confidence scores are below a configured level. This has the advantage of not slowing the process, and not requiring user time and effort, as well as computing and communication resources utilized by the interface, for cases of high confidence. Thus, if the system is e.g. 99% confident of the derived results, it might enrich without human intervention. Note also that in some implementations, the enrichment is done automatically, and the display and confirmation of e.g. steps 860, 864 is done, e.g. in bulk, to provide a validation or confirmation of the already-performed enrichment.

In some such implementations, the displaying is performed based on a weighting of the confidence scores and an amount of the transaction. An example of weighting is the formula “amount of transaction×(1−confidence level)> [configured number]”. The system 110 presents to the user 185 only those records with a high weighted score. The system will tend to present only for those transactions with a high payment, or for a height weighted value of payment amount and lack of confidence. Thus for e.g. a $10 transaction, the risk is low even if the confidence score is only 60%, and the system completes the enrichment automatically. On the other hand, for a $100 million transaction, the business entity is uncomfortable skipping the human confirmation/“second eye”, even if the confidence score is a “high” value of e.g. 90%.

In some examples, a confirmation is received for the counterparty, the financial classification category, and/or the other parameter values, via user device 185 (block 864). In some examples, this is performed by user input/output module 314, e.g. via external interface(s) 155 and communication network(s) (not shown). The output of this step is referred to here also as a confirmed enriched record.

In some examples, the confirmed enriched record derived at block 864 is stored (block 867). In some examples, this block is performed in a manner that is the same as, or similar to, block 825.

The flow continues C to block 870 on FIG. 8D.

In some examples, a determination is made, whether all of the relevant first records 190 indicative of transactions have been enriched—e.g. whether all of them have been run through the relevant enrichers 610 (block 870). In some examples, this is performed by models control module 350.

In some examples, responsive to a determination at block 870 that no, not all records have been processed for enrichment, the flow proceeds to block 875. In some examples, the next layer, or in some cases the next relevant layer, of the enricher architecture 700, 750, is selected (block 875). In some examples, this is performed by models control module 350. The flow continues J, looping back to e.g. block 810 on FIG. 8A. The method 800 is performed in respect of an additional first record(s) 190.

Note that blocks such as 870 and 875 are relevant in implementations where first records are enriched one at a time, or e.g. several at a time. This example situation is disclosed herein, for clarity of illustration. In many other implementations, all of the incoming first records 190 are processed, e.g. in parallel, and each sent to the relevant enrichers 610, and decisions made e.g. by decider 360, such that there is no need for a step 870 to check whether any records remain unprocessed. Similarly, in some implementations first records are continually being obtained by system 110 from first sources 160, and thus the entire method 800 is constantly repeating itself for newly incoming records, as shown with reference to block 887 further herein.

Of course, as additional first records 190 are received and available, the entire flow chart can be repeated, to enrich them as well. This is not shown in the figure.

In some examples, responsive to a determination at block 870 that yes, all first records have been enriched, the flow proceeds to block 880. The two blocks 880 and 883 are in some implementations not strictly part of the record enrichment process, and thus the arrows to them are shown as broken and separate from the main flow chart. These blocks are shown purely to show how the process can continue over time. They can be performed asynchronously, e.g. a relatively long time after the main portion of the flow chart has been run.

In some examples, one or more of the enricher machine learning models 410, 460 is re-trained using the records 530 that have been enriched by the process flow (block 880). Note that also the human user 185 validation/confirmation input provides new, relevant information, provided by a source external to system 110, which can be used to re-train the models. One or more updated machine learning models 410, 460 are thereby obtained. In some examples, second data (e.g. second records 195) has been obtained from second sources 170, and these are used together with the enriched first records 530 to facilitate the re-training. This is particularly true if the user input changed the decision made automatically by the system. The re-training of the models based on the newly enriched records can be performed asynchronously to the enrichment process, e.g. done daily, monthly, after a sufficient number of new records have been reconciled, etc. The number of records considered sufficient for re-training is based on the scope of the particular model.

In some examples, a determination is made, whether one or more machine learning models 610 have changed (block 883). In some examples, this is performed by models control module 350. For example, a new version of a third-party model has been installed. In another example, a new model, not previously used in system 110, has been installed on the system.

As indicated above, this block is typically asynchronous, occurring at a point where the model(s) have changed, e.g. days, weeks or months after a group of records 190 has been enriched.

In some examples, responsive to a determination at block 883 that the set of models has changed, and/or responsive to a determination at block 887 that additional first records are available, the flow continues E, looping back to e.g. block 803 on FIG. 8A. The method 800 is performed again, enriching new first records 190 and/or re-enriching existing enriched records 530. In the latter case, the modified models can be run, for example, to derive additional context, and thus further enrichment, of existing enriched records—e.g. thereby generating updated enriched records 530. Note that as part of the re-processing of enriched records, in some implementations the system 110 further enriches the record(s) in an automated fashion, without asking the user 185 for feedback/confirmation/validation. In some examples, this automatic update is done only for those records which were enriched without human input at e.g. steps 860, 864. (For example, a flag or other indicator in the record can indicate such a status.) For those whose status indicates that they were previously presented to the user, also the further enrichment requires validation/confirmation by a user 185. Although this checking of flag, and alternatives of automated or validated update, are not shown in the flow, for case of exposition, they can be implemented in a manner analogous to that performed for reconciliation/association with reference to blocks 960, 970, 974 of FIG. 9.

Attention is drawn to FIGS. 9A-9D, schematically illustrating a generalized flow chart diagram 800 of a flow of a process or method, for data reconciliation, in, in accordance with some embodiments of the presently disclosed subject matter. This reconciliation process 900 is, in some examples, carried out by systems such as those disclosed with reference to FIGS. 1-7.

Reconciliation is a financial application that matches a received payment 190 with an issued invoice 195, such that the paid invoice 195 will be closed and unpaid invoices 195 will be referred to collection procedures. It is also important, in some cases, for purposes of proper financial visibility and planning, for an organization/entity to understand the number of unpaid invoices and their total amount, etc.

It is not always easy to reconcile and close an invoice that the busy entity issued, since it does not control when the payment will be received, via which bank. Also, the invoice can be in one currency and the received payment in another currency etc.

In reconciliation, one or more actual financial transaction records 190 are matched with one or more accounting information records 195. The matching can be based on the invoice number appearing in the bank transaction, similar counterparty and amount, an amount that matches only one invoice, similar counterparty (or e.g. subsidiary) etc. For example, a payment with transaction number AAA, for $100, was received via bank 160, and it is determined that this payment is for the invoice BBB (e.g. for $100) which is in the general ledger 180, 180A.

In an example of a more complex case, a payment with transaction number CCC, for $500, is associated with two different invoices-DDD for $300, and EEE for $800. In this case, the payment CCC is to pay DDD in full ($300), and to pay only $200 of the $800 owed for EEE. A different payment FFF is made 10 days later, to pay for the remaining $600 associated with invoice EEE. More generally, one financial transaction record can reconcile to multiple invoices, and one invoice can reconcile to multiple financial transaction records.

Note that the first record 190 typically does not contain information to enable easy association with accounting records 195. This is particularly true in complicated cases such as the example of transaction CCC.

Reconciliation is an example of a technical application, conceptually operating at the application layer 260 of FIG. 2. Such an application is based on, and in some cases combined with, the data enrichment layer 230.

In order to, address, inter alia, at least certain issues, challenges and/or problems such as the above, and to provide at least certain corresponding example technical advantages, the presently disclosed subject matter discloses a computerized method, configured to provide data pertaining to matching of records, as well as a computerized system 110 and software products configured to perform such a method.

The method comprises, in some examples, the following:
a. identifying one or more potentially matching second records, having a potential match with at least one enriched first record. The identification in some cases generates also an associated matching confidence score; and
b. providing the potentially matching second record(s).

In some examples, the identification of the potential match(es) utilizes trained machine learning models.

The providing can comprise saving the record, making a decision based on it, or taking some other action based on it. In some examples, the providing comprises displaying, on user device, information indicative of at least one potentially matching second record. For example, it displays information indicative of at least a highest confidence potentially matching second record. In other examples, it can provide several different suggestions.

In other examples, e.g. when the highest confidence potentially matching record is not “high enough” (e.g. is not above a configured threshold value), the application can instead suggest nothing to the user, and the records in question cannot be reconciled at that time. Note that reconciliation is typically done to close the books, to make sure that all payments were received for all invoices.

Note that reconciliation of payments made by the entity, to purchase orders etc. issued by the entity, is typically easier, since both are initiated by the entity, and it thus can have more control. Therefore, in some implementation, the reconciliation method disclosed herein may not reconcile actual financial transaction records and e.g. Purchase Order records in the ERP.

In some such cases, the method further comprises performing the following:
c. receiving, via the user device, an indication of match confirmation of the potential match.

In some examples, the method further comprises:
d. associating the enriched first record with the highest confidence potentially matching second record.

In some examples, the associating comprises at least partly reconciling at least one second record 195, based on the enriched first record 530.

In some examples, the payment or other transaction 190 is checked against all unreconciled ledger entries 195, and in some examples against ledger entries 195 that are only partially reconciled. That is, the identifying of the more potentially matching second record(s) comprises comparing the enriched first record to a plurality of unreconciled second records 195. A plurality of match confidence scores are assigned to the plurality of matches. The identifying is based on relative values of the plurality of match confidence scores.

Reverting to the figure, the flow 900 starts at 905 of FIG. 9A. In some examples, second records 195, indicative of accounting information, are received from second source(s) 170, 180A (block 905). In some examples, this is performed by accounting records input module 317, utilizing e.g. external interfaces 155 and communication network(s). Note that this receiving of records 195 also serves, in some implementations, to facilitate the process of training models 410 based on first records and second records 195. In some implementations, the received second records are stored 550 in data store 150 for future handling, e.g. using data store I/O module 325.

In some examples, a plurality of data tokens are derived, based on parameters of one or more first records 190 (block 910). In some examples, this is performed by transaction records input module 314, by reconciliation module 380, by models control module 350, or e.g. by a tokens creation module (not shown in FIG. 3, for simplicity of exposition). Examples of data tokens include time of transaction, contact person info, amount, regional areas, etc. A token can be a single field, or a combination of multiple fields (e.g. date plus bank information).

The data tokens of this block are referred to herein also as first data tokens and the parameters are referred to as first parameters—to distinguish them from those of step 913 associated with the second records 195, 550.

In some examples, a plurality of additional data tokens are derived, based on parameters of one or more second records 195, 550 (block 913). In some examples, this is performed by accounting records input module 317, by reconciliation module 380, or by other components, e.g. as disclosed with reference to step 910. The data tokens of this block are referred to herein also as second data tokens and the parameters are referred to as second parameters—to distinguish them from those of step 910 associated with the first records 190.

In some examples, the selected first enriched record 190 is run through one or more reconciliation processes (block 920). In some examples, this is performed by reconciliation module 380, e.g. utilizing trained reconciliation machine learning models 410. In some examples, these models 410 are the same as at least some of those models 610, which are used for enriching. In other examples, there are, instead or in addition, dedicated reconciliation models 410, not shown separately from models 410 in the schematic diagrams.

The reconciliation models compare the enriched first record(s) 530 to a plurality of unreconciled second records 550. For example, the first data tokens are compared with the second data tokens. The enriched first record(s) are matched with the second records, based at least on the comparison. In some examples, a match confidence score is associated with each match, thereby assigning a plurality of match confidence scores to a plurality of matches.

Potentially matching second record(s) 550, having a potential match with the enriched first record(s) 530, are identified, based on the comparison, and/or on relative values of the plurality of match confidence scores.

Not that in some cases the reconciler works as an enricher 610, adding context to, and further enriching, first record(s) 530, while comparing it with second records 550.

The flow continues F to FIG. 9B. In some examples, the association is done automatically, without user involvement, and the flow continues to block 940. In the example of the flow 900, there is manual user involvement in confirming the reconciliation, and the flow continues to block 930.

In some examples, the potentially matching second record(s), for the enriched first record, are provided (block 930). In some examples, this is performed by reconciliation module 380. In some implementations, the providing comprises displaying, on a user device 185 to a human user, information indicative of at least a highest confidence potentially matching second record 550. In some examples, this is performed by reconciliation module 380, via user input/output module 314, e.g. via external interface(s) 155 and communication network(s).

For example, the user device displays information about the first record 530, and it displays information about the highest confidential potentially matching second record 550. In another example, several second records are displayed, e.g. the top three (3) matches. In some implementations, also a confidence score is displayed for each displayed match.

In some examples, an indication of match confirmation of the potential match is received, e.g. via the user device 185 (block 935). In some examples, this is performed by reconciliation module 380, via user input/output module 314, e.g. via external interface(s) 155 and communication network(s). For example, the user selects one of the displayed invoices information records 550, as being the matching record; or the user selects “confirm” or “decline” for the single presented invoice information 550.

In some examples, user interaction such as in steps 930, 935 is done only for confidence scores below a certain level (e.g. “below 80%), and/or for transactions above a certain amount (e.g. “above $10,000”). In some examples, a criterion is a weighted result of the confidence and the amount (e.g. a “dollar error value”). Implementations are in some cases similar to those disclosed regarding confirmation of enrichment, e.g. per steps 860 and 864 of FIG. 8. Again, in other implementations, based on score, and in some cases using weighted scores based on transaction amount, the matching can be done automatically, without human intervention.

In some examples, the enriched first record 530 is associated with the relevant second record 550 (block 940). In some cases, the system 110 associates the enriched first record with the highest confidence potentially matching second record 550. In some examples, this is performed by reconciliation module 380. In some examples, this association comprises at least partly reconciling, or otherwise linking, second record(s), based on the enriched first record. The reconciliation may be partial, e.g. in a case where a first record is a payment for only part of an outstanding invoice. For example, the system marks the second record as reconciled, or as partly reconciled, and it links the second record to one or more first records of e.g. payment transactions. The reconciliated second and first records are provided, e.g. are stored as reconciliated in data store 150, output to another system etc.

Note also that in some implementations, the reconciliation/association is done automatically by the system 110, and the display and confirmation of e.g. steps 930, 935, 970, 974 is done asynchronously, e.g. in bulk, to provide a validation or confirmation of the already-performed reconciliation/association.

In some examples, a determination is made, whether all of the relevant second records 195 indicative of accounting/invoice information have been matched/reconciled (block 943). In some examples, this is performed by reconciliation module 380.

In some examples, responsive to a determination at block 943 that no, not all second records have been reconciled, the flow proceeds to block 947. In some examples, the next accounting/invoice record 195 is selected for reconciliation (block 947). The flow loops back J to step 925 of FIG. 9A. Thus, reconciliation is performed in respect of at least one additional first record 530.

In some examples, responsive to a determination at block 943 that yes, all second records have been reconciled, the flow continues G to step 948 of FIG. 9C.

Note that this example flow 900 illustrates only a simplified implementation, in which second records 195, 550 are reconciled, one at a time, with enriched first records 530. In some other implementations, multiple enriched first records 530 and second records 550 are processed in parallel, e.g. checking all payments against all invoices, such that there is no need for a step 943 (and 947) to check whether any records remain unprocessed. In some examples, this can provide better results. Consider an example. The system processes payment P1, and it decides that P1 fits invoice I-1. The invoice is closed/reconciled. The system then moves to payment P2. It now cannot associate P2 to I-1, because record I-1 is already closed. However, it may be that I-1 was a better match for P2, and P1 should have been associated with a different invoice I-6. An implementation in which system 110 is attempting to find a best match of e.g. all against all can therefore have technical advantages.

Similarly, in some implementations first records and second records are continually being obtained by system 110 from first and second sources 160, 170, and the records are continually being enriched. In such a case, the entire method 900 is constantly repeating itself for newly incoming and newly enriched records.

Of course, as additional first and second records are received and enriched, the entire flow chart can be repeated, to enrich them as well. This is not shown in the figure.

In still another example implementation, the process 900 starts with first records 530, and attempts to match each to a corresponding second record(s) 550.

In some examples, the flow proceeds to block 948. The blocks 948 through 978 are in some implementations not strictly part of the reconciliation process, and thus the arrows to them are shown as broken and separate from the main flow chart. These blocks are shown purely to show how the process can continue over time. They can be performed asynchronously, e.g. a relatively long time after the main portion of the flow chart has been run.

In some examples, one or more of the reconciliation machine learning models 410, 460 is re-trained using the records 530, 550 that have been associated/reconciled by the process flow (block 948). Note that also the human user 185 validation/confirmation input provides new, relevant information, provided by a source external to system 110, which can be used to re-train the models. One or more updated machine learning models 410, 460 are thereby obtained. This is particularly true if the user input changed the decision made automatically by the system. The re-training of the models based on the newly reconciled records can be performed asynchronously to the reconciliation process, e.g. done daily, monthly, after a sufficient number of new records have been reconciled, etc. In some examples, ten, or several dozen, newly reconciled records (e.g. of one business entity or one bank) with such manual input can be enough. The number of records considered sufficient for re-training is based on the scope of the particular model.

In some examples, a determination is made, whether there has been a change in the relevant machine learning models, e.g. the reconciliation model(s) 410 and/or relevant enricher models 410 (block 950). In some examples, this is performed by reconciliation module 380, e.g. utilizing models control module 350. For example, a new version of a third-party model has been installed. In another example, a new model, not previously used in system 110, has been installed on the system.

As indicated above, this block is typically asynchronous, occurring at a point where the model(s) have changed, e.g. days, weeks or months after a group of records 530, 550 has been reconciled.

In some examples, responsive to a determination that no, there has been no change in the machine learning model(s), the flow loops back 957 to step 950, waiting for a change in the models.

In some examples, responsive to a determination that yes, there has been a change in the machine learning (ML) model(s), the flow continues to block 954. In some examples, another run of at least some of the ML models, or of other reconciliation processes, is performed (block 954). The step can function much like step 925. For at least some enriched first records 530, other potentially matching second records 550 are identified. For example, P1 earlier had been matched and reconciled with invoice I-1, but using the newer model versions, it can be that invoice I-5 will be determined to be in fact a better match with P1. I-5 is now a potential match with P1. These matches are referred to herein, for clarity, also as second potential matches.

In block 958, a second match confidence score(s) is assigned to the second potential match(es). This can be performed e.g. by reconciliation module 380.

The flow continues H to step 960 of FIG. 9BD.

In some examples, a determination is made, whether the earlier match was associated with the indication of match confirmation via the user device 185 (block 950). In some examples, this is performed by reconciliation module 380. An indication that the earlier match received user confirmation can be stored with the enriched first record 530, and/or with the accounting (second) record 550. Looking e.g. at the earlier match of P1 and E-1, a determination was made whether in steps 930 and 935 that potential match was presented to a human user 185 for confirmation, before the reconciliation was done. If this is true, in some cases it may be desirable to present also the second potential match for confirmation.

In some examples, responsive to a determination that no, the earlier match was not being associated with the indication of match confirmation via the user device, the flow continues directly to step 978, disclosed further herein.

In some examples, responsive to a determination that yes, the earlier match was being associated with the indication of match confirmation via the user device the flow continues to block 970. In some examples, an alert is sent, about the second potential match, via user device 185 (block 970). For example, the user is alerted that P1 was previously reconciled with I-1, but that the system suggests/proposes I-5 as a better match. For example, information about each record is presented, and in some cases the relevant match confidence scores.

The logic of this example implementation is that since the user had to approve the reconciliation, they should also approve changes in the reconciliation.

In some examples, an indication to perform the second association is received, via user device 185 (block 974).

In some examples, blocks 970 and 974 are performed utilizing component similar to, or the same, as those used in steps 930 and 935.

In some examples, a second association is performed, between the enriched first record 530 and the one or more other potentially matching second records 550 (block 978). In some examples, this is performed by reconciliation module 380. Again, if no manual confirmation is required, the system can do an automatic change of the reconciliation/association.

Although in the flowchart blocks such as 930, 935, 970, 974 are shown in as part of a serial flow, this is done only for ease of exposition. In more typical implementations, the automated association/reconciliation process is performed for a number of enriched first records 530 and invoice records 195, 550, and the display and confirmation of e.g. 930, 935, 970, 974 are done in a bulk manner, asynchronously from the reconciling of each record.

Although not shown, if there is a change to the models (e.g. per block 950), and/or new records have been enriched, the relevant blocks of the flow can be repeated. Note that the flow can also be seen as looping back to FIG. 8, where the reconciliation of records can be used as input to the re-training of enricher models, and also for further enrichment of records. In some examples, FIGS. 8 and 9 can be seen as one extended process, with enriching and reconciliation of records feeding to each other.

In some embodiments, one or more steps of the flowcharts exemplified herein may be performed automatically. The flow and functions illustrated in the flowchart figures may for example be implemented in system 110 and in processing circuitry 120, and they may make use of components described with regards to FIGS. 1-7. It is also noted that whilst the flowchart is described with reference to system elements that realize steps, such as for example system 110 and processing circuitry 120, this is by no means binding, and the operations can be carried out by elements other than those described herein.

It is noted that the teachings of the presently disclosed subject matter are not bound by the flowcharts illustrated in the various figures.

For example, some of the operations or steps can be integrated into a consolidated operation, or can be broken down into several operations, and/or other operations may be added. As a non-limiting example, in some cases blocks 954, 958, can be combined.

In embodiments of the presently disclosed subject matter, fewer, more and/or different stages than those shown in the figures can be executed. As one non-limiting example, certain implementations may not include one or more of blocks 930, 935, 970, 974.

One or more stages illustrated in the figures can be executed in a different order and/or one or more groups of stages may be executed simultaneously. As one example, block 913 can be performed before block 910. In the claims that follow, alphanumeric characters and Roman numerals, used to designate claim elements such as components and steps, are provided for convenience only, and do not imply any particular order of performing the steps.

It should be noted that the word “comprising” as used throughout the appended claims, is to be interpreted to mean “including but not limited to”.

While there has been shown and disclosed examples in accordance with the presently disclosed subject matter, it will be appreciated that many changes may be made therein without departing from the spirit of the presently disclosed subject matter.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter may be, at least partly, a suitably programmed computer. Likewise, the presently disclosed subject matter contemplates a computer program product being readable by a machine or computer, for executing the method of the presently disclosed subject matter, or any part thereof. The presently disclosed subject matter further contemplates a non-transitory machine-readable or computer-readable memory tangibly embodying a program of instructions executable by the machine or computer for executing the method of the presently disclosed subject matter or any part thereof. The presently disclosed subject matter further contemplates a non-transitory computer readable storage medium having a computer readable program code embodied therein, configured to be executed so as to perform the method of the presently disclosed subject matter.

Those skilled in the art will readily appreciate that various modifications and changes can be applied to the embodiments of the invention as hereinbefore described without departing from its scope, defined in and by the appended claims.

1. A system configured to provide data pertaining to a record, comprising a processing circuitry, the processing circuitry configured to perform the following method:
a. obtain, from at least one first source, a first record indicative of an actual financial transaction, paid via the first source;
b. perform enrichment on the first record, thereby determining at least one of: a counterparty associated with the first record; and a financial classification category associated with the first record,
wherein the performing of the enrichment utilizes at least one machine learning model trained to identify correspondence, of first records indicative of actual financial transactions associated with a business entity, to second data,
wherein the second data are obtained from at least one second source, distinct from the at least one first source;
c. derive an enriched first record, based on the enrichment; and
d. provide the enriched first record.

2. The system of claim 1, the method further comprising:
e. perform the steps (a) to (d) in respect of at least one additional first record, the at least one additional first record constituting the first record.

3. The system of claim 1, configured to obtain, from a plurality of first sources, a plurality of first records indicative of a plurality of actual financial transactions, a record of the plurality of first records constituting the first record.

4. The system of claim 1, wherein at least one of the following is true:
A. the second data comprise second records indicative of accounting information associated with the business entity;
B. the at least one first source is a system associated with one of: a bank, an investment company, a payment service provider (PSP); and
C. the at least one second source is a system associated with one is one of a general ledger and an enterprise resource planning (ERP) system, associated with the business entity.

5. The system of claim 1, wherein one or more portions of the first record are of a non-fixed format,
wherein the performing of the enrichment comprises analyzing the one or more portions of the first record having the non-fixed format.

6. The system of claim 1, wherein the performing of the enrichment comprises:
I. performing a plurality of enrichment processes,
wherein each enrichment process of the plurality of enrichment processes determines an item of added information indicative of the actual financial transaction.

7. The system of claim 6,
wherein at least some enrichment processes of the plurality of enrichment processes determine:
(1) at least one of a respective potential counterparty and a respective potential financial classification category, associated with the first record,
thereby generating a plurality of respective potential counterparties, a plurality of respective potential financial classification categories,
wherein the performing of the enrichment further comprises: determining at least the counterparty, and/or at least the financial classification category, based at least on: the plurality of respective potential counterparties and/or on the plurality of respective potential financial classification categories;

8. The system of claim 7, wherein the performing of the enrichment further comprises:
II. determining one or more confidence scores associated with the counterparty and with the payment classification category.

9. The system of claim 8,
wherein, in said step (I), the at least some enrichment processes further determine:
(2) at least one respective confidence score associated with the determination,
thereby generating a plurality of corresponding respective confidence scores,
wherein the determining at least the counterparty, and/or at least the financial classification category, of said step (II), is based at least on the plurality of corresponding respective confidence scores.

10. The system of claim 8, the method further comprising:
f. displaying, on a user device, at least the counterparty and/or, the financial classification category, and optionally the confidence scores; and
g. receiving, via the user device, confirmation of the counterparty and/or of the financial classification category.

11. The system of claim 6, wherein the performing of the enrichment further comprises:
III. selecting enrichment processes of the plurality of processes to perform, based on selection criteria.

12. The system of claim 11, wherein the selection criteria are selected from a group comprising:
i. a relevance of a selected enrichment process to the at least one first record;
ii. a relevance of the selected enrichment process to the business entity;
iii. a relative priority of the selected enrichment process;
iv. a dependence of the selected enrichment process on at least one other enrichment process; and
v. configurable rules.

13. The system of claim 11, wherein the at least one enrichment processes further perform identification of at least one of:
i. transfers within subsidiaries of the business entity;
ii. transfers between of the business entity and a subsidiary; and
iii. transfers within the business entity.

14. The system of claim 6, wherein the plurality of enrichment processes perform at least identification of one of the following:
(i) a format of the one or more portions of the first record;
(ii) financial services associated with the first record;
(iii) business entities associated with the first record;
(iv) whether the actual financial transaction is an intercompany transaction;
(v) transaction type;
(vi) deposits;
(vii) withdrawals;
(viii) bank fees;
(ix) income through a financial vendor;
(x) payroll transaction;
(xi) office expenses;
(xii) cloud services expenses;
(xiii) security services expenses;
(xiv) web-related expenses;
(xv) tax payments;
(xvi) social security payments; and
(xvii) software license fees.

15. The system of claim 1, the method further comprising:
h. identify at least one potentially matching second record, having a potential match with the enriched first record, with an associated matching confidence score;
i. providing the at least one potentially matching second record.

16. The system of claim 15, the method further comprising:
j. perform the steps (k) to (l) in respect of at least one additional first record,
the at least one additional first record constituting the first record.

17. The system of claim 15, wherein the providing comprises displaying, on a user device, information indicative of at least one potentially matching second record,
wherein the method further comprising performing the following:
k. receiving, via the user device, an indication of match confirmation of the potential match.

18. The system of claim 15, wherein the providing comprises:
l. associating the enriched first record with the highest confidence potentially matching second record.

19. A computerized method of providing data pertaining to a record, the method performed by a processing circuitry of a system, the computerized method comprising:
a. obtaining, from at least one first source, a first record indicative of an actual financial transaction, paid via the first source;
b. performing enrichment on the first record, thereby determining at least one of: a counterparty associated with the first record; and a financial classification category associated with the first record,
wherein the performing of the enrichment utilizes at least one machine learning model trained to identify correspondence, of first records indicative of actual financial transactions associated with a business entity, to second data,
wherein the second data are obtained from at least one second source, distinct from the at least one first source;
c. deriving an enriched first record, based on the enrichment; and
d. providing the enriched first record.

20. A non-transitory computer readable storage medium tangibly embodying a program of instructions that, when executed by a processing circuitry of a system a record, cause the processing circuitry to perform a method of providing data pertaining to a record, the method comprising:
a. obtaining, from at least one first source, a first record indicative of an actual financial transaction, paid via the first source;
b. performing enrichment on the first record, thereby determining at least one of: a counterparty associated with the first record; and a financial classification category associated with the first record,
wherein the performing of the enrichment utilizes at least one machine learning model trained to identify correspondence, of first records indicative of actual financial transactions associated with a business entity, to second data,
wherein the second data are obtained from at least one second source, distinct from the at least one first source;
c. deriving an enriched first record, based on the enrichment; and
d. providing the enriched first record.
